(19) United States
(12) Patent Application Publication
(10) Pub. No.: US 2025/0304779 A1
(43) Pub. Date: Oct. 2, 2025

(54) AIR CURABLE ETHYLENE/ALPHA-OLEFIN INTERPOLYMER COMPOSITIONS

(71) Applicant: Dow Global Technologies LLC, Midland, MI (US)

(72) Inventors: Yunfeng Yang, Shanghai (CN); Colin Li Pi Shan, Pearland, TX (US); Yabin Sun, Shanghai (CN); Bo Lyu, Shanghai (CN); Jeffrey C. Munro, Bellaire, TX (US)

(21) Appl. No.: 18/866,664

(22) PCT Filed: Aug. 12, 2022
(86) PCT No.: PCT/CN2022/112059

§ 371 Date: Nov. 18, 2024

(51) Int. Cl. C08L 23/0807; C08F 210/16; C08J 3/24; C08K 5/14; C08K 5/3492; C08K 5/357

(52) U.S. Cl. CPC C08L 23/0815; C08F 210/16; C08J 3/247; C08K 5/14; C08K 5/34924; C08K 5/357; C08J 2323/08; C08L 2205/025

(57) ABSTRACT

A composition comprising the following components a) through c): a) at least one ethylene/alpha-olefin interpolymer that comprises the following properties: i) a density 0.855 to 0.900 g/cc and ii) a total unsaturation≥0.20/1000 C, b) at least one Tempo compound of Structure I); and c) at least one peroxide; and wherein the molar ratio of the NO· from component b to the peroxide (O—O) bonds from component c is from 0.30 to 0.90; and wherein component b is present in an amount from 0.20 to 0.90 phr, based on 100 parts of component a; and wherein Structure I is selected from Structure IA, Structure IB or Structure IC, each as described herein. Also, processes to form a crosslinked composition from above composition and related compositions.

### BACKGROUND OF THE INVENTION

Vulcanized EPDM is the incumbent material for weatherstrip profiles. Vulcanized EPDM is highly filled with carbon black and oil, and is cured by a complex sulfur curative system. Nowadays, the automotive industry is demanding light-weight materials (especially for electric cars), less conductive materials, and materials with lower VOC/odor. Typical vulcanized EPDM cannot meet all these needs.

For various applications, like footwear and PV films, the peroxide curing of an olefin-based elastomer (polyolefin elastomer (POE)) composition is typically completed in the absence of oxygen. When the POE is cured via peroxide in the presence of oxygen, carbon radicals react with oxygen, and these products degrade to polar functionalities, such as, carboxylic acids, carbonyls and esters. These polar species create a tacky surface, which is unacceptable, especially when the cured surface is the outmost layer of the final product. To reduce surface tackiness, a peroxide curing process requires more expensive and complicated equipment (for example, salt baths) to remove oxygen from the crosslinking environment. There is a need for new compositions that are air curable and provide tack-free surfaces. Further such compositions should meet most or all of the requirements for light-weight materials for automotive applications.

U.S. Publication 2020/0263018 discloses a composition comprising the following: A) an ethylene/alpha-olefin/diene interpolymer; B) a peroxide comprising at least one peroxide bond; and C) a bis-TEMPO compound having the Structure (I) as described therein. The ratio of the molar amount of nitroxide groups of component C to the molar amount of the peroxide bonds of component B is from 0.100:1.000 to 2.000:1.000. See abstract.

International Publication WO2020/140067 discloses a curable composition comprising the following: A) a polyolefin component and B) a curing component comprising a cross-linking agent. The polyolefin component comprises an unsaturated polyolefin of the formula A¹L¹, and where L¹ is a polyolefin, and A¹ is selected from the group consisting of a vinyl group, a vinylidene group of the formula CH₂═C(Y¹)—, a vinylene group of the formula Y¹CH═CH—, a mixture of a vinyl group and a vinylene group of the formula Y¹CH═CH—, a mixture of a vinyl group and a vinylidene group of the formula CH₂═C(Y¹)—, a mixture of a vinylidene group of the formula CH₂═C(Y¹)— and a vinylene group of the formula Y¹CH═CH—, and a mixture of a vinyl group, a vinylidene group of the formula CH₂═C(Y¹)—, and a vinylene group of the formula Y¹CH═CH—; and Y¹ at each occurrence independently is a C1 to C30 hydrocarbyl group. See claim 1. The curing component may also contain a scorch inhibitor/retardant, such as a hindered phenol, a semi hindered phenol; TEMPO; a TEMPO derivative; 1,1-diphenylethylene; 2,4-diphenyl-4-methyl-1-pentene; and allyl-containing compounds described in U.S. Pat. No. 6,277,925B1. See paragraph [0247]. See also WO2020/140061, WO2020/135681, WO2020/135708, WO2020/135680, WO2020/139993 and WO2020/140058.

U.S. Pat. No. 8,581,094 discloses an electronic device module comprising the following: A) at least one electronic device, and B) a polymeric material in intimate contact with at least one surface of the electronic device. The polymeric material comprises components (1) and optionally (2) and (3) as follows: (1) a polyolefin copolymer with at least one of (a) a density of less than about 0.90 g/cc, (b) a 2% secant modulus of less than about 150 mega Pascal (mPa), (c) a melt point of less than about 95° C., (d) an alpha-olefin content of at least about 15 and less than about 50 wt %, based on the weight of the polymer, (e) a Tg of less than about −35° C., and (f) a SCBDI of at least about 50, (2) optionally, a free radical initiator (e.g., a peroxide or azo compound) or a photoinitiator (e.g., benzophenone), and (3) optionally, a co-agent. See abstract. Typically, the polyolefin copolymer is an ethylene/alpha-olefin copolymer. Optionally, the polymeric material can further comprise a vinyl silane and/or a scorch inhibitor, and the copolymer can be uncrosslinked or crosslinked. See abstract. Scorch inhibitors include 4-hydroxy-2,2,6,6-tetramethylpiperidin-1-oxyl also known as nitroxyl 2, or NR 1, or 4-oxypiperidol, or tanol, or tempol, or tmpn, or 4-hydroxy-TEMPO (see column 11, lines 30-54).

J. Kruzelak, et al., Vulcanization of Rubber Compounds with Peroxide Curing Systems, Rubber Chemistry and Technology, 90(1), 60-88, 2017; discloses the characterization of organic peroxides as curing agents and their decomposition mechanisms. This reference also discloses the classification and characterization of co-agents used in peroxide cross-linking, and the mutual interactions and reaction mechanisms between peroxide, co-agents, and rubber matrices, in relation to the properties of prepared materials. See abstract. This reference discloses scorch retardants such as 2,6-di-tert-butyl-4-methylphenol (BHT); 2,4-diphenyl-4-methyl-1-pentene (methyl styrene dimer, MSD); 1,1-diphenylethylene (DPE); (2,2,6,6-tetramethyl-piperidin-1-yl)oxyl (TEMPO); bis-(2,2,6,6-tetramethyl-4-piperidinyl) sebacate (bis-TEMPO); or acrylate-functionalized TEMPO; 4-acryloyloxy-2,2,6,6-tetramethyl-piperidine-N-oxyl (AOTEMPO). See page 83.

However, as discussed above, there remains a need for new compositions which are air curable and provide tack-free surfaces. Further such compositions should meet all or most of the requirements for light-weight materials for automotive applications. These needs have been met by the follow invention.

### SUMMARY OF THE INVENTION

In a first aspect, a composition comprising the following components a) through c):
a) at least one ethylene/alpha-olefin interpolymer that comprises the following properties: i) a density 0.855 to 0.900 g/cc and ii) a total unsaturation 0.20/1000 C,
b) at least one Tempo compound of Structure I); and
c) at least one peroxide;
and wherein the molar ratio of the NO from the at least one Tempo compound (component b) to the peroxide (O—O) bonds from the at least one peroxide (component c) is from 0.30 to 0.90;
and wherein component b is present in an amount from 0.20 to 0.90 phr, based on 100 parts of component a; and
wherein Structure I is selected from Structure IA, Structure IB or Structure IC, each as described herein.

In a second aspect, a process to form a crosslinked composition, the process comprising thermally treating a composition comprising the following components a) through c):
a) at least one ethylene/alpha-olefin interpolymer that comprises the following properties: i) a density 0.855 to 0.900 g/cc and ii) a total unsaturation ≥0.20/1000 C,
b) at least one Tempo compound of Structure I); and
c) at least one peroxide;
and wherein the molar ratio of the NO from the at least one Tempo compound (component b) to the peroxide (O—O) bonds from the at least one peroxide (component c) is from 0.30 to 0.90;
and wherein component b is present in an amount from 0.20 to 0.90 phr, based on 100 parts of component a; and
wherein Structure I is selected from Structure IA, Structure IB or Structure IC, each as described herein.

In a third aspect, a process to form a crosslinked composition, the process comprising at least the following steps A and B:
A) extruding a composition comprising the following components a) through c) to form a pre-crosslinked composition:
a) at least one ethylene/alpha-olefin interpolymer that comprises the following properties: i) a density 0.855 to 0.900 g/cc, and ii) a total unsaturation ≥0.20/1000 C,
b) at least one Tempo compound of Structure I); and
c) at least one peroxide;
B) thermally treating the pre-crosslinked composition in air, at a temperature ≥150° C., to form the crosslinked composition; and
wherein Structure I is selected from Structure IA, Structure IB or Structure IC, each as described herein.

### BRIEF DESCRIPTION OF THE FIGURES

FIG. 1 depicts FTIR-ATR profiles of the surfaces of inventive and comparative compositions after air cured. The profiles from top to bottom are as follows: CS1, CS3, CS7, CS9 and IE1.

### DETAILED DESCRIPTION OF THE INVENTION

Compositions have been discovered that contain a high content of polymer and which extrude well and cure efficiently in air. It has been discovered that such compositions can be air cured without resulting in a tacky surface.

As discussed above, in a first aspect, a composition is provided comprising components a) through c) as discussed herein. In a second aspect, a process to form a crosslinked composition, the process comprising thermally treated a composition comprising the following components a) through c) as discussed herein. In a third aspect, a process to form a crosslinked composition is provided, comprising at least the following steps A and B as discussed herein. Each composition may comprise a combination of two or more embodiments, as described herein. Each process may comprise a combination of two or more embodiments, as described herein. Each component a, b and c may comprise a combination of two or more embodiments, as described herein. The following embodiments apply to the first, second and third aspects unless noted otherwise.

Note, as used herein, in reference to Structure IA, Structure IB or Structure IC (see component b), R1=R¹, R2=R², R3=R³, etc. Also, in regard to the number of carbon atoms in a chemical substituent of Structure IA, Structure IB or Structure IC, the notation, for example, “C1-C18,” where “1 through 18” represents consecutive numbers from 1 to 18, refers to “from 1 to 18 carbon atoms” that may be present in the substituent. An “alkyl” group may be linear, branched, cyclic, or any combination thereof. An “alkylene” group may be linear, branched, cyclic, or any combination thereof.

In one embodiment, or a combination of two or more embodiments, each described herein, the ethylene/alpha-olefin interpolymer is selected from a telechelic ethylene/alpha-olefin interpolymer of the formula A¹L¹L²A², as described herein, or an unsaturated ethylene/alpha-olefin interpolymer of the formula A¹L¹, as described herein, and further from an unsaturated ethylene/alpha-olefin interpolymer of the formula A¹L¹, as described herein.

In one embodiment, or a combination of two or more embodiments, each described herein, the ethylene/alpha-olefin interpolymer is an ethylene/alpha-olefin copolymer.

In one embodiment, or a combination of two or more embodiments, each described herein, the component a further comprises a second ethylene/alpha-olefin interpolymer with a density from 0.855 to 0.900 g/cc, and a total unsaturation 0.20/1000 C, and this second interpolymer is different from the ethylene/alpha-olefin interpolymer.

In one embodiment, or a combination of two or more embodiments, each described herein, the second ethylene/alpha-olefin interpolymer is selected from a telechelic ethylene/alpha-olefin interpolymer of the formula A¹L¹L²A², as described herein, or an unsaturated ethylene/alpha-olefin interpolymer of the formula A¹L¹, as described herein, and further from an unsaturated ethylene/alpha-olefin interpolymer of the formula A¹L¹, as described herein.

In one embodiment, or a combination of two or more embodiments, each described herein, the second ethylene/alpha-olefin interpolymer is an ethylene/alpha-olefin copolymer.

In one embodiment, or a combination of two or more embodiments, each described herein, the ratio of the density of the ethylene/alpha-olefin to the density of the second ethylene/alpha-olefin is ≥0.80, or ≥0.85, or ≥0.90, or ≥0.92, or ≥0.94, or ≥0.96, or ≥0.98 or ≥1.0, and/or ≤1.25, or ≤1.20, or ≤1.18, or ≤1.16, or ≤1.14, or ≤1.12, or ≤1.11.

In one embodiment, or a combination of two or more embodiments, each described herein, the weight ratio of the ethylene/alpha-olefin to the second ethylene/alpha-olefin is ≥0.50, or ≥1.0, or ≥2.0, or ≥3.0, or ≥3.5, or ≥4.0, or ≥4.5, or ≥5.0, or ≥5.5 and/or ≤20, or ≤15, or ≤10, or ≤9.0, or ≤8.0, or ≤7.5, or ≤7.0, or ≤6.5, or ≤6.0.

In one embodiment, or a combination of two or more embodiments, each described herein, the composition comprises 10.0 wt %, or ≤5.0 wt %, or ≤2.0 wt %, or ≤1.0 wt %, or ≤0.5 wt %, or ≤0.1 wt % of a filler (for example, carbon black), based on the weight of the composition; and further the composition does not comprise a filler. Fillers include, but are not limited to, carbon black, talc, glass fiber, carbon fiber, calcium carbon, magnesium hydroxide, ATH (Aluminum Trihydrate), TiO2 or any combination thereof.

In one embodiment, or a combination of two or more embodiments, each described herein, the composition comprises ≥90.0 wt %, or ≥94.0 wt %, or ≥96.0 wt %, or ≥97.0 wt % or ≥97.5 wt %, or ≥98.0 wt %, or ≥98.5 wt %, or ≥99.0 wt %, or ≥99.5 wt % and/or ≤100.0 wt %, or ≤99.9 wt %, or ≤99.8 wt %, or ≤99.7 wt % of the sum of components a, b and c, based on the weight of the composition.

In one embodiment, or a combination of two or more embodiments, each described herein, in regard to the second aspect, the thermal treatment takes place in air. In one embodiment, or a combination of two or more embodiments, each described herein, in regard to the second aspect, the thermally treated takes place at a temperature ≥150° C., or ≥155° C., or ≥160° C., or ≥165° C., or ≥170° C., or ≥175° C., or ≥180° C., or ≥185° C., or ≥190° C., or ≥195° C., or ≥200° C. and/or at a temperature ≤240° C., or ≤235° C., or ≤230° C., or ≤225° C., or ≤220° C., or ≤215° C., or ≤210° C., or ≤205° C.

In one embodiment, or a combination of two or more embodiments, each described herein, in regard to the second or third aspect, the composition is extruded at an average barrel temperature ≥60° C., or ≥65° C., or ≥70° C., or ≥75° C., or ≥80° C., or ≥85° C., or ≥90° C., or ≥95° C., or ≥100° C., or ≥105° C., or ≥110° C. and/or at a temperature ≤150° C., or ≤145° C., or ≤135° C., or ≤130° C., or ≤125° C., or ≤120° C., or ≤115° C.

In one embodiment, or a combination of two or more embodiments, each described herein, in regard to the third aspect, for step B, the pre-crosslinked composition is thermally treated at a temperature ≥150° C., or ≥155° C., or ≥160° C., or ≥165° C., or ≥170° C., or ≥175° C., or ≥180° C., or ≥185° C., or ≥190° C., or ≥195° C., or ≥200° C. and/or at a temperature ≤240° C., or ≤235° C., or ≤230° C., or ≤225° C., or ≤220° C., or ≤215° C., or ≤210° C., or ≤205° C.

In one embodiment, or a combination of two or more embodiments, each described herein, for the composition, the molar ratio of the NO· from component b to the peroxide (O—O) bonds from component c is ≥0.30, or ≥0.31, or ≥033, or ≥0.34, and/or ≤0.90, or ≤0.88, or ≤0.85, or ≤0.82, or ≤0.80, or ≤0.78, or ≤0.75, or ≤0.72, or ≤0.70, or ≤0.68, or ≤0.65, or ≤0.62, or ≤0.60, or ≤0.58.

In one embodiment, or a combination of two or more embodiments, each described herein, for the composition, component b is present in an amount ≥0.20, or ≥0.22, or ≥0.25, or ≥0.28, or ≥0.30, or ≥0.32, or ≥0.35, or ≥0.38, or ≥0.40, or ≥0.42 or ≥0.45 phr, and/or ≤0.90, or ≤0.88, or ≤0.85, or ≤0.82, or ≤0.80, or ≤0.78, or ≤0.75 phr, based on 100 parts of component a.

Also provided is a crosslinked composition formed from a composition of one or more embodiments as described herein, or from a process of one or more embodiments as described herein. Also provided is an article comprising at least one component formed from a composition of one or more embodiments as described herein.

### Ethylene/Alpha-Olefin Interpolymer (Component a)

An ethylene/alpha-olefin interpolymer comprises, in polymerized form, ethylene, and an alpha-olefin. Alpha-olefins include, but are not limited to, a C3-C20 alpha-olefins, further C3-C10 alpha-olefins, further C3-C8 alpha-olefins, such as propylene, 1-butene, 1-hexene, and 1-octene. The distribution of the monomeric units, and in particular, the alpha-olefin, may be random, block, homogeneous, heterogeneous, etc. Preferably, the interpolymer is a random interpolymer (i.e., comprises a random distribution of its monomeric constituents).

In one embodiment, the ethylene/alpha-olefin interpolymers is a telechelic ethylene/alpha-olefin interpolymer of the formula A¹L¹L²A², or an unsaturated ethylene/alpha-olefin interpolymer of the formula A¹L¹.

Telechelic ethylene/alpha-olefin interpolymers, such as those of the A¹L¹L²A² (Formula I), and unsaturated ethylene/alpha-olefin interpolymers, such as those of the A¹L¹ (Formula II), are each described below. See also, for example, WO 2020/140058 and WO 2020/140067, each incorporated herein by reference.

Telechelic ethylene/alpha-olefin interpolymer of Formula I: A¹L¹L²A², wherein:
L¹ is an ethylene/alpha-olefin interpolymer, and further an ethylene/alpha-olefin copolymer; note, L¹ (divalent) is bonded to A¹ and L².
A¹ is selected from the group consisting of the following:
a) a vinyl group, b) a vinylidene group of the formula CH₂═C(Y¹)—, c) a vinylene group of the formula Y¹CH═CH—, d) a mixture of a vinyl group and a vinylene group of the formula Y¹CH═CH—, e) a mixture of a vinyl group and a vinylidene group of the formula CH₂═C(Y¹)—, f) a mixture of a vinylidene group of the formula CH₂═C(Y¹)— and a vinylene group of the formula Y¹CH═CH—, and g) a mixture of a vinyl group, a vinylidene group of the formula CH₂═C(Y¹)—, and a vinylene group of the formula Y¹CH═CH—;
Y¹ at each occurrence, independently, is a C₁ to C₃₀ hydrocarbyl group;
L² is a C₁ to C₃₂ hydrocarbylene group; and
A² is a hydrocarbyl group comprising a hindered double bond.

Unsaturated ethylene/alpha-olefin interpolymer of Formula II: A¹L¹, wherein:
L¹ is an ethylene/alpha-olefin interpolymer, and further an ethylene/alpha-olefin copolymer; note, L¹ (monovalent) is bonded to A¹;
A¹ is selected from the group consisting of the following: a) a vinyl group, b) a vinylidene group of the formula CH₂═C(Y¹)—, c) a vinylene group of the formula Y¹CH═CH—, d) a mixture of a vinyl group and a vinylene group of the formula Y¹CH═CH—, e) a mixture of a vinyl group and a vinylidene group of the formula CH₂═C(Y¹)—, f) a mixture of a vinylidene group of the formula CH₂═C(Y¹)— and a vinylene group of the formula Y¹CH═CH—, and g) a mixture of a vinyl group, a vinylidene group of the formula CH₂═C(Y¹)—, and a vinylene group of the formula Y¹CH═CH—; and Y¹ at each occurrence, independently, is a C₁ to C₃₀ hydrocarbyl group.

For Formula I and Formula II, L¹ at each occurrence independently is an ethylene/alpha-olefin interpolymer, as described above, and may result, in part, from the polymerization (for example, coordination polymerization) of unsaturated monomers (and comonomers). Examples of suitable monomers (and comonomers) include, but are not limited to, ethylene and alpha-olefins of 3 to 30 carbon atoms, further 3 to 20 carbon atoms, such as, for example, propylene, 1-butene, 1-pentene, 3-methyl-1-butene, 1-hexene, 4-methyl-1-pentene, 3-methyl-1-pentene, 3,5,5-trimethyl-lhexene, 1-octene, 1-decene, 1-dodecene, 1-tetradecene, 1-hexadecene, 5-ethyl-1-nonene, 1-octadecene and 1-eicosene; conjugated or nonconjugated dienes, such as, for example, butadiene, isoprene, 4-methyl-1,3-pentadiene, 1,3-pentadiene, 1,4-pentadiene, 1,5-hexadiene, 1,4-hexadiene, 1,3-hexadiene, 1,5-heptadiene, 1,6-heptadiene, 1,3-octadiene, 1,4-octadiene, 1,5-octadiene, 1,6-octadiene, 1,7-octadiene, 1,9-decadiene, 7-methyl-1,6-octadiene, 4-ethylidene-8-methyl-1,7-nonadiene, and 5,9-dimethyl-1,4,8-decatriene, 5-methyl-1,4-hexadiene, 3,7-dimethyl-1,6-octadiene, 3,7-dimethyl-1,7-octadiene, and mixed isomers of dihydromyrcene and dihydroocimene; norbornene and alkenyl, alkylidene, cycloalkenyl and cycloalkylidene norbornenes, such as 5-ethylidene-2-norbornene, 5-vinyl-2-norbornene, dicyclopentadiene, 5-methylene-2-norbornene, 5-propenyl-2-norbornene, 5-isopropylidene-2-norbornene, 5-(4-cyclopentenyl)-2-norbornene, 5-cyclohexylidene-2-norbornene, and norbornadiene; and aromatic vinyl compounds such as styrenes, mono or polyalkylstyrenes (including styrene, o-methylstyrene, t-methylstyrene, m-methylstyrene, p-methylstyrene, o-dimethylstyrene, o-ethylstyrene, m-ethylstyrene and p-ethylstyrene). Preferred monomers include ethylene and alpha-olefins of 3 to 30 carbon atoms, further 3 to 20 carbon atoms.

### Tempo Compound (Component b)

A Tempo compound has the Structure IA, Structure IB or Structure IC, each as described herein. Tempo compounds include, but are not limited to, bis-(2,2,6,6-tetramethyl-1-piperidinyloxy-4-yl) sebacate.

### Peroxides

As used herein, a peroxide contains at least one oxygen-oxygen bond (O—O). Peroxides include, but are not limited to, dialkyl, diaryl, dialkaryl, or diaralkyl peroxide, having the same or differing respective alkyl, aryl, alkaryl, or aralkyl moieties, and further each dialkyl, diaryl, dialkaryl, or diaralkyl peroxide, having the same respective alkyl, aryl, alkaryl, or aralkyl moieties.

Examples of organic peroxides include dicumyl peroxide (“DCP”); tert-butyl peroxybenzoate; di-tert-amyl peroxide (“DTAP”); bis(t-butyl-peroxy isopropyl) benzene (“BIPB”); isopropylcumyl t-butyl peroxide; t-butylcumylperoxide; di-t-butyl peroxide; 2,5-bis(tert-butylperoxy)-2,5-dimethylhexane (“LUPEROX 101”); 2,5-bis(t-butylperoxy)-2,5-dimethylhexyne-3; 1,1-bis(t-butylperoxy)3,3,5-trimethylcyclohexane; isopropylcumyl cumylperoxide; butyl 4,4-di(tert-butylperoxy)valerate; di(isopropylcumyl) peroxide; 1,1-di-(tert-butylperoxy)-cyclohexane (“LUPEROX 331”); 1,1-di-(tert-amylperoxy)cyclohexane (“LUPEROX 531”); tert-butylperoxyacetate (“TBPA”); tert-amyl peroxyacetate (“TAPA”); tert-butylperoxy-2-ethylhexyl carbonate (“TBEC”); and mixtures of two or more thereof.

The peroxide may be a cyclic peroxide. Examples of cyclic peroxides include those derived from acetone, methylamyl ketone, methylheptyl ketone, methylhexyl ketone, methylpropyl ketone, methylbutyl ketone, diethyl ketone, methylethyl ketone, methyloctyl ketone, methylnonyl ketone, methyldecyl ketone, methylundecyl ketone and combinations thereof, among others. The cyclic peroxides can be used alone or in combination with one another. A number of cyclic peroxides are commercially available, for example, under the tradename TRIGONOX, such as 3,6,9-triethyl-3,6,9-trimethyl-1,4,7-triperoxonane.

### Additives

An inventive composition may comprise one or more additives. Additives include, but are not limited to, crosslinking coagents, blowing agents, anti-oxidants, UV stabilizers, colorants, processing aids (for example, zinc stearate).

Crosslinking coagents, include, but are not limited to, triallyl isocyanurate (TAIC), triallyl cyanurate (TAC), triallyl trimellitate (TATM), trimethylolpropane triacylate (TMPTA), trimethylolpropane trimethylacrylate (TMPTMA), 1,6-hexanediol diacrylate, pentaerythritol tetraacrylate, dipentaerythritol penta acrylate, tris-(2-hydroxy ethyl) isocyanurate triacrylate, trivinyl cyclohexane (TVCH), or combinations thereof. Additional coagents include alkenyl-functional monocyclic organosiloxanes, as disclosed in WO 2019/000311 and WO 2019/000654, which are incorporated herein by reference in their entirety (for example, a monocyclic organosiloxane of the formula [R1,R2SiO2/2]n, wherein subscript n is an integer greater than or equal to 3; each R1 is independently a (C2-C4)alkenyl or a H₂C═C(R1a)-C(═O)—O—(CH₂)m- wherein R1a is H or methyl and subscript m is an integer from 1 to 4; and each R2 is independently H, (C1-C4)alkyl, phenyl, or R1; for example 2,4,6,8-tetramethyl-2,4,6,8-tetravinyl cyclotetrasiloxane, 2,4,6-trimethyl-2,4,6-trivinyl-cyclotrisiloxane, or a combination thereof).

In one embodiment, an additive is present in an amount ≥0.10, or ≥0.20, or ≥0.30, or ≥0.35 phr, based on 100 parts of component a, and/or ≤5.0, or ≤4.0, or ≤3.0, or ≤2.0, or ≤1.0 wt %, or ≤0.50 phr, based on 100 parts of component a.

### Definitions

Unless stated to the contrary, implicit from the context, or customary in the art, all parts and percents are based on weight, and all test methods are current as of the filing date of this disclosure.

The term “composition,” as used herein, includes a mixture of materials, which comprise the composition, as well as reaction products and decomposition products formed from the materials of the composition. Any reaction product or decomposition product is typically present in trace or residual amounts.

The term “polymer,” as used herein, refers to a polymeric compound prepared by polymerizing monomers, whether of the same or a different type. The generic term polymer thus, includes the term homopolymer (employed to refer to polymers prepared from only one type of monomer, with the understanding that trace amounts of impurities can be incorporated into the polymer structure), and the term interpolymer as defined hereinafter. Trace amounts of impurities, such as catalyst residues, can be incorporated into and/or within the polymer. Typically, a polymer is stabilized with very low amounts (“ppm” amounts) of one or more stabilizers.

The term “interpolymer,” as used herein, refers to polymer prepared by the polymerization of at least two different types of monomers. The term interpolymer thus includes the term copolymer (employed to refer to polymers prepared from two different types of monomers) and polymers prepared from more than two different types of monomers.

The term “olefin-based polymer,” as used herein, refers to a polymer that comprises, in polymerized form, 50 wt % or a majority weight percent of an olefin, such as ethylene or propylene (based on the weight of the polymer), and optionally may comprise one or more comonomers.

The term “propylene-based polymer,” as used herein, refers to a polymer that comprises, in polymerized form, a majority weight percent of propylene (based on the weight of the polymer), and optionally may comprise one or more comonomers.

The term “ethylene-based polymer,” as used herein, refers to a polymer that comprises, in polymerized form, 50 wt % or a majority weight percent of ethylene (based on the weight of the polymer), and optionally may comprise one or more comonomers.

The term “ethylene/alpha-olefin interpolymer,” as used herein, refers to interpolymer that comprises, in polymerized form, 50 wt % or a majority weight percent of ethylene (based on the weight of the interpolymer), and an alpha-olefin.

The term, “ethylene/alpha-olefin copolymer,” as used herein, refers to a copolymer that comprises, in polymerized form, 50 wt % or a majority weight percent of ethylene (based on the weight of the copolymer), and an alpha-olefin, as the only two monomer types.

The phrase “a majority weight percent,” as used herein, in reference to a polymer (for example, interpolymer or copolymer), refers to the amount of monomer present in the greatest amount in the polymer.

The term “heteroatom,” refers to an atom other than hydrogen or carbon (for example, O, S, N or P). The term “heteroatom group” refers to a heteroatom or a chemical group containing one or more heteroatoms.

The terms “hydrocarbon,” “hydrocarbyl,” and similar terms, as used herein, refer to a respective compound or chemical group, etc., containing only carbon and hydrogen atoms. A divalent “hydrocarbylene group” is defined in similar manner.

The terms “heterohydrocarbon,” “heterohydrocarbyl,” and similar terms, as used herein, refer to a respective hydrocarbon,” or “hydrocarbyl group, etc., in which at least one carbon atom is substituted with a heteroatom group (for example, O, S, N or P). The monovalent heterohydrocarbyl group may be bonded to the remaining compound of interest via a carbon atom or via a heteroatom. A divalent “heterohydrocarbylene group” is defined in similar manner; and the divalent heterohydrocarbylene group may be bonded to the remaining compound of interest via two carbon atoms, or two heteroatoms, or a carbon atom and a heteroatom.

The terms “substituted hydrocarbon,” “substituted hydrocarbyl group,” and similar terms, as used herein, refer to a respective hydrocarbon or hydrocarbyl group, etc., in which one or more hydrogen atoms is/are independently substituted with a heteroatom group. A “substituted hydrocarbylene group” is defined in similar manner.

The terms “substituted heterohydrocarbon,” “substituted heterohydrocarbyl group,” and similar terms, as used herein, refer to a respective heterohydrocarbon or heterohydrocarbyl group, etc., in which one or more hydrogen atoms is/are independently substituted with a heteroatom group. A “substituted heterohydrocarbylene group” is defined in similar manner.

The term “crosslinked composition,” as used herein, refers to a composition that has a network structure due to the formation of chemical bonds between polymer chains. The degree of formation of this network structure is indicated by an increase in the “MH-ML” differential, relative to the non-crosslinked composition. A crosslinked composition typically has a gel content 60 wt %, further 70 wt %, further ≥80 wt %, further 90 wt %, based on the weight of the crosslinked composition. Gel content may be determined by refluxing the crosslinked composition in xylene. For example, around 0.5 g of crosslinked composition (Ws) is sealed in a metal mesh (mesh number is 120), to form a packed sample, and the packed sample is weighed (Wt1). The packed sample is then transferred to a flask (500 ml), equipped with condenser, and containing 350 ml xylene. After refluxing for five hours, the packed samples is removed from xylene, and put into vacuum oven, and heated at 120° C., for two hours, under vacuum condition. After which time, the packed sample is removed from the oven, and weighed (Wt2). Gel content=1−[(Wt1−Wt2)/Ws]*100%.

The terms “thermally treating,” “thermally treated,” “thermal treatment,” and similar terms, as used herein, in reference to a composition comprising an ethylene/alpha-olefin interpolymer as discussed herein, refer to increasing the temperature of the composition by the application of heat. As an example, heat may be applied by electrical means (for example, a heating coil) and/or by radiation and/or by hot oil and/or by mechanical shearing. Note, the temperature at which the thermal treatment takes place, refers to the temperature of the “heat-applying” device, or, if the device contains an enclosed or semi-enclosed atmosphere, the temperature of the atmosphere within the device, such as, for example, the atmosphere within an oven or a tunnel (for example, the air temperature in an hot air oven or a hot air tunnel).

The term “extruder configuration,” as used herein, refers to the arrangement and number of extruders (n≥1) used in an extrusion process. Typically, two or more extruders are arranged in a series orientation.

The term “average barrel temperature,” as used herein, in reference to an extrusion process using one or more extruders, each containing at least one barrel, refers to the average temperature of the sum of the barrel temperatures if two or more barrels are present, and if only one barrel is present, the temperature of this barrel.

The term “Garvey Die,” as used herein, in reference to an extrusion process, refers to a die of certain geometry that conforms to ASTM D2230-17, and which allows for the observation of the appearance and contours of an extrudate.

The terms “comprising,” “including,” “having,” and their derivatives, are not intended to exclude the presence of any additional component, step or procedure, whether the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure, not specifically delineated or listed.

### Listing of Some Compositions and Processes

A] A composition comprising the following components a) through c):
   a) at least one ethylene/alpha-olefin interpolymer that comprises the following properties: i) a density 0.855 to 0.900 g/cc and ii) a total unsaturation ≥0.20/1000 C,
   b) at least one Tempo compound of Structure I) below; and
   c) at least one peroxide;
   and wherein the molar ratio of the NO from the at least one Tempo compound (component b) to the peroxide (O—O) bonds from the at least one peroxide (component c) is from 0.30 to 0.90;
   and wherein component b is present in an amount from 0.20 to 0.90 phr, based on 100 parts of component a; and
   wherein Structure I is selected from Structure IA, Structure IB or Structure IC, each as follows:
   Structure IA is

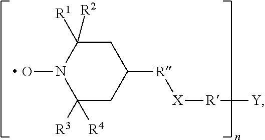

wherein n is an integer ≥1;
R1, R2, R3 and R4 are each independently selected from H or a C1-C18 alkyl;
X is selected from CH₂, ether (—O—), thioether (—Sₘ—, where m≥1), carbonyl (—C(O)—), ester (—O—C(O)— or —C(O)—O—), amine (—N(R)—), amide (—N(R)—C(O)— or —C(O)—N(R)—), urethane (—O—C(O)—NH— or —NH—C(O)—O—), carbamide (—NH—C(O)—NH—), or imide (—C(O)—N(R)—C(O)—);
R′ is selected from a C1-C30 alkylene;
R″ may or may not be present, and if present, R″ is selected from a C1-C30 alkylene;
Y is selected from CR₄₋ₙ where n=1 to 4, OR₂₋ₙ where n=1 to 2, NR₃₋ₙ where n=1 to 3, SR₂₋ₙ where n=1 to 2, PR₃₋ₙ where n=1 to 3, PR₅₋ₙ where n=1 to 5, SiR₄₋ₙ where n=1 to 4, a bifunctional C—C core, a phenyl core, a phenyl core substituted with ester, a phenyl core substituted with amide, a tris-isocyanurate core, or a melamine core; and
wherein the bifunctional C—C core is selected from the following structures, where each R′ represents the divalent R′ group in Structure IA above:

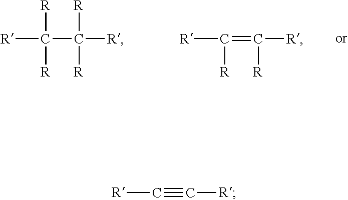

wherein the phenyl core is selected from the following structures, where each R′ represents the divalent R′ group in Structure IA above:

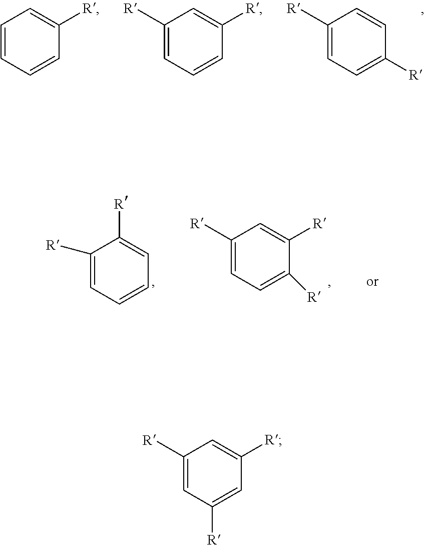

the phenyl core substituted with ester is selected from the following structures, where each R′ represents the divalent R′ group in Structure IA above:

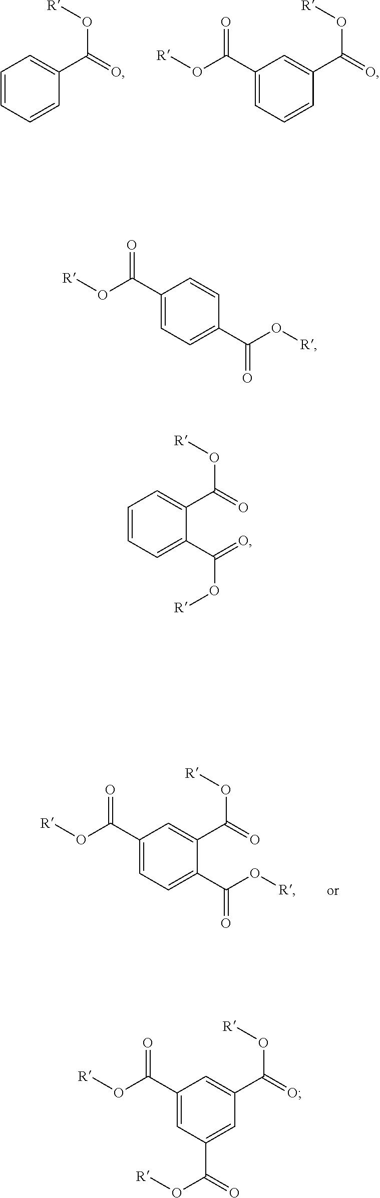

the phenyl core substituted with amide is selected from the following structures, where each R′ represents the divalent R′ group in Structure IA above:

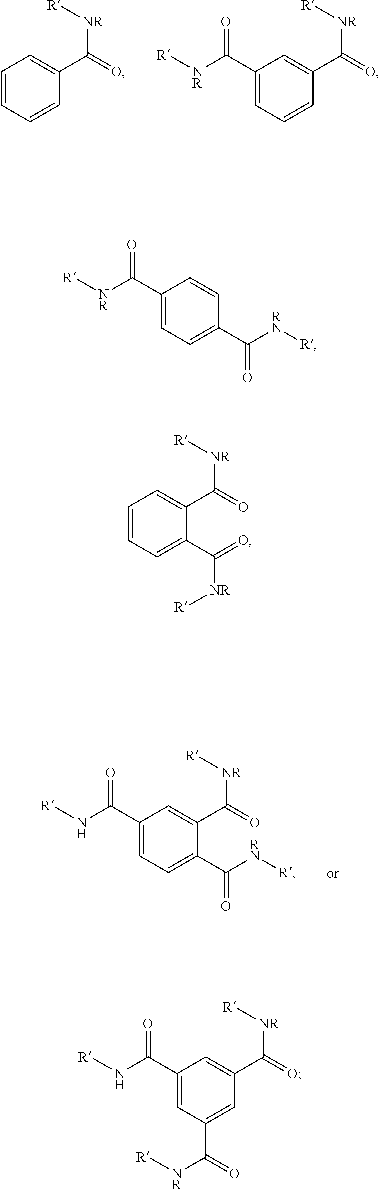

the tris-isocyanurate core is as follows, where each R′ represents the divalent R′ group in Structure IA above;

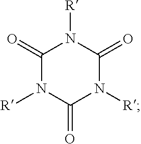

the melamine core is as follows, where each R′ represents the divalent R′ group in Structure IA above;

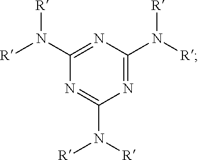

and
wherein each R group in Structure IA is independently selected from H, an unsubstituted hydrocarbyl, a substituted hydrocarbyl, an unsubstituted heterohydrocarbyl or a substituted heterohydrocarbyl;
Structure IB comprises sub-structure IB) as follows:

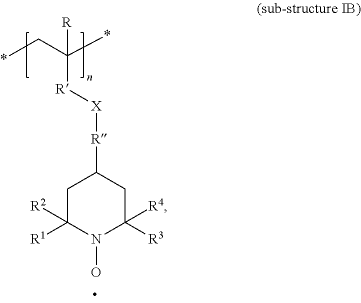

wherein n is an integer ≥1;
R1, R2, R3 and R4 are each independently selected from H or a C1-C18 alkyl;
X is selected from CH₂, ether (—O—), thioether (—Sₘ—, where m≥1), carbonyl (—C(O)—), ester (—O—C(O)— or —C(O)—O—), amine (—N(R)—), amide (—N(R)—C(O)— or —C(O)—N(R)—), urethane (—O—C(O)—NH— or —NH—C(O)—O—), carbamide (—NH—C(O)—NH—), or imide (—C(O)—N(R)—C(O)—);
R′ is selected from a C1-C30 alkylene;
R″ may or may not be present, and if present, R″ is selected from a C1-C30 alkylene;
each R group in sub-structure IB is independently selected from H, an unsubstituted hydrocarbyl, a substituted hydrocarbyl, an unsubstituted heterohydrocarbyl or a substituted heterohydrocarbyl;
each * (asterisk) in sub-structure IB represents the respective chemical end of Structure IB;
Structure IC comprises sub-structure IC) as follows:

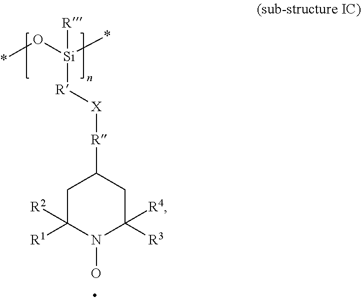

wherein n is an integer ≥1;
R1, R2, R3 and R4 are each independently selected from H or a C1-C18;
X is selected from CH₂, ether (—O—), thioether (—Sₘ—, where m≥1), carbonyl (—C(O)—), ester (—O—C(O)— or —C(O)—O—), amine (—N(R)—), amide (—N(R)—C(O)— or —C(O)—N(R)—), urethane (—O—C(O)—NH— or —NH—C(O)—O—), carbamide (—NH—C(O)—NH—), or imide (—C(O)—N(R)—C(O)—);
R′ is selected from a C1-C30 alkylene;
R″ may or may not be present, and if present, R″ is selected from a C1-C30 alkylene;
each R′″ group in sub-structure IC is independently selected from an unsubstituted hydrocarbyl, a substituted hydrocarbyl, an unsubstituted heterohydrocarbyl or a substituted heterohydrocarbyl;
each R group in sub-structure IC is independently selected from H, an unsubstituted hydrocarbyl, a substituted hydrocarbyl, an unsubstituted heterohydrocarbyl or a substituted heterohydrocarbyl;
each * (asterisk) in sub-structure IC represents the respective chemical end of Structure IC, and if n≥3, then each end may or may not form a cyclic structure with the other end.
B] The composition of A] above, wherein the ethylene/alpha-olefin interpolymer has a density ≥0.856, or ≥0.858, or ≥0.860, or ≥0.862, or ≥0.864, or ≥0.866 g/cc, and/or ≤0.898, or ≤0.896, or ≤0.894, or ≤0.892, or ≤0.890, or ≤0.888, or ≤0.886, or ≤0.884, or ≤0.882, or ≤0.880, or ≤0.878, or ≤0.876, or ≤0.874, or ≤0.872 g/cc (1 cc=1 cm³).
C] The composition of A] or B] above, wherein the ethylene/alpha-olefin interpolymer has a total unsaturation ≥0.22/1000 C, or ≥0.24/1000 C, or ≥0.26/1000 C, or ≥0.28/1000 C, or ≥0.30/1000 C, or ≥0.35/1000 C, or ≥0.40/1000 C, or ≥0.45/1000 C, or ≥0.50/1000 C, or ≥0.55/1000 C, or ≥0.60/1000 C, or ≥0.65/1000 C, and/or ≤15.0/1000 C, or ≤10.0/1000 C, or ≤5.00/1000 C, or ≤2.00/1000 C, or ≤1.80/1000 C, or ≤1.60/1000 C, or ≤1.50/1000 C, or ≤1.40/1000 C, or ≤1.30/1000 C, or ≤1.20/1000 C, or ≤1.10/1000 C, or ≤1.00/1000 C.
D] The composition of any one of A]-C](A] through C]) above, wherein the ethylene/alpha-olefin interpolymer has a melt index (I2, in dg/min) ≥0.1, or ≥0.2, or ≥0.4, or ≥0.6, or ≥0.8, or ≥1.0, or ≥1.2, or ≥1.4, or ≥1.6, or ≥1.8, or ≥2.0, and/or ≤2000, or ≤1000, or ≤500, or ≤200, or ≤100, or ≤50, or ≤45, or ≤40, or ≤35, or ≤30, or ≤25, or ≤20.
E] The composition of any one of A]-D] above, wherein the ethylene/alpha-olefin interpolymer is selected from a telechelic ethylene/alpha-olefin interpolymer of the formula A¹L¹L²A², as described herein, or an unsaturated ethylene/alpha-olefin interpolymer of the formula A¹L¹, as described herein, and further from an unsaturated ethylene/alpha-olefin interpolymer of the formula A¹L¹, as described herein.
F] The composition of any one of A]-E] above, wherein the ethylene/alpha-olefin interpolymer is an ethylene/alpha-olefin copolymer.
G] The composition of any one of A]-F] above, wherein the alpha-olefin of the ethylene/alpha-olefin interpolymer is a C₃-C₂₀ alpha-olefin, further a C₃-C₁₀ alpha-olefin, and further propylene, 1-butene, 1-hexene or 1-octene, further propylene, 1-butene or 1-octene, further 1-butene or 1-octene, further 1-octene.
H] The composition of any one of A]-G] above, wherein the ethylene/alpha-olefin interpolymer does not comprise, in polymerized form, ENB, and further a diene monomer, and further a polyene monomer.
I] The composition of any one of A]-H] above, wherein component a further comprises a second ethylene/alpha-olefin interpolymer with a density from 0.855 to 0.900 g/cc, and a total unsaturation ≥0.20/1000 C, and this second interpolymer is different from the ethylene/alpha-olefin interpolymer, and further different in one or more features selected from density, total unsaturation, melt index (I2), or any combination therein.
J] The composition of I] above, wherein the second ethylene/alpha-olefin interpolymer has a density ≥0.856, or ≥0.858, or ≥0.860, or ≥0.862, or ≥0.864, or ≥0.866 g/cc, and/or ≤0.898, or ≤0.896, or ≤0.894, or ≤0.892, or ≤0.890, or ≤0.888, or ≤0.886, or ≤0.884, or ≤0.882, or ≤0.880, or ≤0.878, or ≤0.876, or ≤0.874, or ≤0.872 g/cc, or ≤0.870 g/cc.
K] The composition of I] or J] above, wherein the second ethylene/alpha-olefin interpolymer has a total unsaturation ≥0.22/1000 C, or ≥0.24/1000 C, or ≥0.26/1000 C, or ≥0.28/1000 C, or ≥0.30/1000 C, or ≥0.35/1000 C, or ≥0.40/1000 C, or ≥0.45/1000 C, or ≥0.50/1000 C, or ≥0.55/1000 C, or ≥0.60/1000 C, or ≥0.65/1000 C, and/or ≤15.0/1000 C, or ≤10.0/1000 C, or ≤5.00/1000 C, or ≤2.00/1000 C, or ≤1.80/1000 C, or ≤1.60/1000 C, or ≤1.50/1000 C, or ≤1.40/1000 C, or ≤1.30/1000 C, or ≤1.20/1000 C, or ≤1.10/1000 C, or ≤1.00/1000 C.
L] The composition of any one of I]-K] above, wherein the second ethylene/alpha-olefin interpolymer has a melt index (I2, in g/10 min or dg/min) ≥0.1, or ≥0.2, or ≥0.4, or ≥0.6, or ≥0.8, or ≥1.0, and/or ≤2000, or ≤1000, or ≤500, or ≤200, or ≤100, or ≤50, or ≤40, or ≤30, or ≤20, or ≤10, or ≤5.0, or ≤2.0.
M] The composition of any one of I]-L] above, wherein the second ethylene/alpha-olefin interpolymer is selected from a telechelic ethylene/alpha-olefin interpolymer of the formula A¹L¹L²A², as described herein, or an unsaturated ethylene/alpha-olefin interpolymer of the formula A¹L¹, as described herein, and further from an unsaturated ethylene/alpha-olefin interpolymer of the formula A¹L¹, as described herein.
N] The composition of any one of I]-M] above, wherein the second ethylene/alpha-olefin interpolymer is an ethylene/alpha-olefin copolymer.
O] The composition of any one of I]-N] above, wherein the alpha-olefin of the second ethylene/alpha-olefin interpolymer is a C₃-C₂₀ alpha-olefin, further a C₃-C₁₀ alpha-olefin, and further propylene, 1-butene, 1-hexene or 1-octene, further propylene, 1-butene or 1-octene, further 1-butene or 1-octene, further 1-octene.
P] The composition of any one of J]—O] above, wherein the second ethylene/alpha-olefin interpolymer does not comprise, in polymerized form, ENB, and further a diene monomer, and a polyene monomer.
Q] The composition of any one of I]-P] above, wherein the ethylene/alpha-olefin interpolymer and the second ethylene/alpha-olefin interpolymer are each, independently, selected from a telechelic ethylene/alpha-olefin interpolymer of the formula A¹L¹L²A², as described herein, or an unsaturated ethylene/alpha-olefin interpolymer of the formula A¹L¹, as described herein, and further from an unsaturated ethylene/alpha-olefin interpolymer of the formula A¹L¹, as described herein.
R] The composition of any one of I]-Q] above, wherein the ratio of the density of the ethylene/alpha-olefin to the density of the second ethylene/alpha-olefin is 0.80, or ≥0.85, or ≥0.90, or ≥0.92, or ≥0.94, or ≥0.96, or ≥0.98 or ≥1.0, and/or ≤1.25, or ≤1.20, or 1.18, or ≤1.16, or ≤1.14, or ≤1.12, or ≤1.11.
S] The composition of any one of I]-R] above, wherein the ratio of the total unsaturation of the ethylene/alpha-olefin to the total unsaturation of the second ethylene/alpha-olefin is 0.8, or ≥0.9, or ≥1.0, or ≥1.2, or ≥1.4, or ≥1.6, or ≥1.8 or ≥2.0, and/or ≤5.0, or ≤4.5, or ≤4.0, or ≤3.8, or ≤3.6, or ≤3.4, or ≤3.2, or ≤3.0, or ≤2.8, or ≤2.6, or ≤2.4, or ≤22.
T] The composition of any one of I]-S] above, wherein the ratio of the melt index (I2) of the ethylene/alpha-olefin to the melt index (I2) of the second ethylene/alpha-olefin is ≥0.8, or ≥6.0, or ≥8.0, or ≥10, or ≥15, or ≥20, or ≥25 or ≥30, and/or ≤100, or ≤80, or ≤60, or ≤50, or ≤45, or ≤40, or ≤35.
U] The composition of any one of I]-T] above, wherein the weight ratio of the ethylene/alpha-olefin to the second ethylene/alpha-olefin is ≥0.50, or ≥1.0, or ≥0.0, or ≥3.0, or ≥3.5, or ≥4.0, or ≥4.5, or ≥5.0, or ≥5.5 and/or ≤20, or ≤15, or ≤10, or ≤9.0, or ≤8.0, or ≤7.5, or ≤7.0, or ≤6.5, or ≤6.0.
V] The composition of any one of I]-U], wherein the component a comprises ≥80.0 wt %, or ≥85.0 wt %, or ≥90.0 wt %, or ≥95.0 wt %, or ≥98.0 wt %, or ≥99.0 wt %, or ≥99.2 wt %, or ≥99.4 wt %, or ≥99.6 wt %, or ≥99.7 wt % and/or ≤100.0 wt %, or ≤99.9 wt %, or ≤99.8 wt %, of the sum of the ethylene/alpha-olefin and the second ethylene/alpha-olefin, based on the weight of component a.
W] The composition of any one of A]-H], wherein the component a comprises ≥80.0 wt %, or ≥85.0 wt %, or ≥90.0 wt %, or ≥95.0 wt %, or ≥98.0 wt %, or ≥99.0 wt %, or ≥99.2 wt %, or ≥99.4 wt %, or ≥99.6 wt %, or ≥99.7 wt % and/or 100.0 wt %, or ≤99.9 wt %, or ≤99.8 wt %, of the ethylene/alpha-olefin, based on the weight of component a.
A2]A process to form a crosslinked composition, the process comprising at least the following steps A and B:
   A) extruding a composition comprising the following components a) through c) to form a pre-crosslinked composition:
   a) at least one ethylene/alpha-olefin interpolymer that comprises the following properties: i) a density 0.855 to 0.900 g/cc, and ii) a total unsaturation ≥0.20/1000 C,
   b) at least one Tempo compound of Structure I); and
   c) at least one peroxide;
   B) thermally treating the pre-crosslinked composition in air, at a temperature ≥150° C., to form the crosslinked composition; and wherein Structure I is selected from Structure IA, Structure IB or Structure IC, each as described herein (see A] above).
   B2] The process of A2] above, wherein, for step A, the composition is extruded at an average barrel temperature ≥60° C., or ≥65° C., or ≥70° C., or ≥75° C., or ≥80° C., or ≥85° C., or ≥90° C., or ≥95° C., or ≥100° C., or ≥105° C., or ≥110° C. and/or ≤150° C., or ≤145° C., or ≤140° C., or ≤135° C., or ≤130° C., or ≤125° C., or ≤120° C., or ≤115° C.
C2] The process of A2] or B2] above, wherein, for step B, the pre-crosslinked composition is thermally treated at a temperature ≥150° C., or ≥155° C., or ≥160° C., or ≥165° C., or ≥170° C., or ≥175° C., or ≥180° C., or 185° C., or ≥190° C., or ≥195° C., or ≥200° C. and/or at a temperature ≤240° C., or ≤235° C., or ≤230° C., or ≤225° C., or ≤220° C., or ≤215° C., or ≤210° C., or ≤205° C.
D2] The process of any one of A2]-C2] above, wherein, for step B, the pre-crosslinked composition is thermally treated in a continuous hot oven or hot air tunnel.
E2] The process of any one of A2]-D2] above, wherein, for step A, the composition is extruded in an extruder configuration, in series, which comprises a Garvey Die at the end of the last extruder in the extruder configuration.
F2] The process of any one of A2]-E2] above, wherein, for the composition, the molar ratio of the NO from component b to the peroxide (O—O) bonds from component c is from 0.30 to 0.90.
G2] The process of any one of A2]-F2] above, wherein, for the composition, component b is present in an amount from 0.20 to 0.90 phr, based on 100 parts of component a.
H2] A process to form a crosslinked composition, the process comprising thermally treating a composition comprising the following components a) through c):
   a) at least one ethylene/alpha-olefin interpolymer that comprises the following properties: i) a density 0.855 to 0.900 g/cc, and ii) a total unsaturation ≥0.20/1000 C,
   b) at least one Tempo compound of Structure I); and
   c) at least one peroxide;
   and wherein the molar ratio of the NO· from the at least one Tempo compound (component b) to the peroxide (O—O) bonds from the at least one peroxide (component c) is from 0.30 to 0.90;
   and wherein component b is present in an amount from 0.20 to 0.90 phr, based on 100 parts of component a; and wherein Structure I is selected from Structure IA, Structure IB or Structure IC, each as described herein (see A] above).
I2] The process of H2] above, wherein the thermal treatment takes place in air.
J2] The process of H2] or 12] above, wherein the composition is thermally treated at a temperature ≥150° C., or ≥155° C., or ≥160° C., or ≥165° C., or ≥170° C., or ≥175° C., or ≥180° C., or ≥185° C., or ≥190° C., or ≥195° C., or ≥200° C. and/or at a temperature ≤240° C., or ≤235° C., or ≤230° C., or ≤225° C., or ≤220° C., or ≤215° C., or ≤210° C., or ≤205° C.
K2] The process of any one of H2]-J2] above, wherein the composition is extruded before being thermally treated.
L2] The process of K2] above, wherein the composition is extruded at an average barrel temperature ≥60° C., or ≥65° C., or ≥70° C., or ≥75° C., or ≥80° C., or ≥85° C., or ≥90° C., or ≥95° C., or ≥100° C., or ≥105° C., or ≥110° C. ≤150° C., or ≤145° C., or ≤140° C., or ≤135° C., or ≤130° C., or ≤125° C., or ≤120° C., or ≤115° C.
M2] The process of any one of A2]-L2] above, wherein the ethylene/alpha-olefin interpolymer has a density ≥0.856, or ≥0.858, or ≥0.860, or ≥0.862, or ≥0.864, or ≥0.866 g/cc, and/or ≤0.898, or ≤0.896, or ≤0.894, or ≤0.892, or ≤0.890, or ≤0.888, or ≤0.886, or ≤0.884, or ≤0.882, or ≤0.880, or ≤0.878, or ≤0.876, or ≤0.874, or ≤0.872 g/cc.
N2] The process of any one of A2]-M2] above, wherein the ethylene/alpha-olefin interpolymer has a total unsaturation ≥0.22/1000 C, or ≥024/1000 C, or ≥0.26/1000 C, or ≥0.28/1000 C, or ≥0.30/1000 C, or ≥0.35/1000 C, or ≥0.40/1000 C, or ≥0.45/1000 C, or ≥0.50/1000 C, or ≥0.55/1000 C, or ≥0.60/1000 C, or ≥0.65/1000 C, and/or ≤15.0/1000 C, or ≤10.0/1000 C, or ≤5.00/1000 C, or ≤2.00/1000 C, or ≤1.80/1000 C, or ≤1.60/1000 C, or ≤1.50/1000 C, or ≤1.40/1000 C, or ≤1.30/1000 C, or ≤1.20/1000 C, or ≤1.10/1000 C, or 1.00/1000 C.
O2] The process of any one of A2]-N2] above, wherein the ethylene/alpha-olefin interpolymer has a melt index (I2, in g/10 min or dg/min) ≥0.1, or ≥0.2, or ≥0.4, or ≥0.6, or ≥0.8, or ≥1.0, or ≥1.2, or ≥1.4, or ≥1.6, or ≥1.8, or ≥2.0, and/or ≤2000, or ≤1000, or ≤500, or ≤200, or ≤100, or ≤50, or ≤45, or ≤40, or ≤35, or ≤30, or ≤25, or 20.
P2] The process of any one of A2]-02] above, wherein the ethylene/alpha-olefin interpolymer is selected from a telechelic ethylene/alpha-olefin interpolymer of the formula A¹L¹L²A², as described herein, or an unsaturated ethylene/alpha-olefin interpolymer of the formula A¹L¹, as described herein, and further from an unsaturated ethylene/alpha-olefin interpolymer of the formula A¹L¹, as described herein.
Q2] The process of any one of A2]-P2] above, wherein the ethylene/alpha-olefin interpolymer is an ethylene/alpha-olefin copolymer.
R2] The process of any one of A2]-Q2] above, wherein the alpha-olefin of the ethylene/alpha-olefin interpolymer is a C3-C20 alpha-olefin, further a C₃-C₁₀ alpha-olefin, and further propylene, 1-butene, 1-hexene or 1-octene, further propylene, 1-butene or 1-octene, further 1-butene or 1-octene, further 1-octene.
S2] The process of any one of A2]-R2] above, wherein the alpha-olefin of the ethylene/alpha-olefin interpolymer does not comprise, in polymerized form, ENB, and further a diene monomer, and further a polyene monomer.
T2] The process of any one of A2]-S2] above, wherein component a further comprises a second ethylene/alpha-olefin interpolymer with a density from 0.855 to 0.900 g/cc, and a total unsaturation ≥0.20/1000 C, and this second interpolymer is different from the ethylene/alpha-olefin interpolymer, and further different in one or more features selected from density, total unsaturation, melt index (I2), or any combination therein.
U2] The process of T2] above, wherein the second ethylene/alpha-olefin interpolymer has a density ≥0.856, or ≥0.858, or ≥0.860, or ≥0.862, or ≥0.864, or ≥0.866 g/cc, and/or ≤0.898, or ≤0.896, or ≤0.894, or ≤0.892, or ≤0.890, or ≤0.888, or ≤0.886, or ≤0.884, or ≤0.882, or ≤0.880, or ≤0.878, or ≤0.876, or ≤0.874, or ≤0.872 g/cc, or ≤0.871 g/cc.
V2] The process of T2] or U2] above, wherein the second ethylene/alpha-olefin interpolymer has a total unsaturation ≥0.22/1000 C, or ≥0.24/1000 C, or ≥0.26/1000 C, or ≥0.28/1000 C, or ≥0.30/1000 C, or ≥0.35/1000 C, or ≥0.40/1000 C, or ≥0.45/1000 C, or ≥0.50/1000 C, or ≥0.55/1000 C, or ≥0.60/1000 C, or ≥0.65/1000 C, and/or ≤15.0/1000 C, or ≤10.0/1000 C, or ≤5.00/1000 C, or ≤2.00/1000 C, or ≤1.80/1000 C, or ≤1.60/1000 C, or ≤1.50/1000 C, or ≤1.40/1000 C, or ≤1.30/1000 C, or ≤1.20/1000 C, or ≤1.10/1000 C, or 1.00/1000 C.
W2] The process of any one of T2]-V2] above, wherein the second ethylene/alpha-olefin interpolymer has a melt index (I2, in g/10 min or dg/min) ≥0.1, or ≥0.2, or ≥0.4, or ≥0.6, or ≥0.8, or ≥1.0, and/or ≤2000, or ≤1000, or ≤500, or ≤200, or ≤100, or ≤50, or ≤40, or ≤30, or ≤20, or ≤10, or ≤5.0, or ≤2.0.
X2] The process of any one of T2]-W2] above, wherein the second ethylene/alpha-olefin interpolymer is selected from a telechelic ethylene/alpha-olefin interpolymer of the formula A¹L¹L²A², as described herein, or an unsaturated ethylene/alpha-olefin interpolymer of the formula A¹L¹, as described herein, and further from an unsaturated ethylene/alpha-olefin interpolymer of the formula A¹L¹, as described herein.
Y2] The process of any one of T2]-X2] above, wherein the second ethylene/alpha-olefin interpolymer is an ethylene/alpha-olefin copolymer.
Z2] The process of any one of T2]-Y2] above, wherein the alpha-olefin of the second ethylene/alpha-olefin interpolymer is a C3-C20 alpha-olefin, further a C₃-C₁₀ alpha-olefin, and further propylene, 1-butene, 1-hexene or 1-octene, further propylene, 1-butene or 1-octene, further 1-butene or 1-octene, further 1-octene.
A3] The process of any one of T2]-Z2] above, wherein the second ethylene/alpha-olefin interpolymer does not comprise, in polymerized form, ENB, and further a diene monomer, and further a polyene monomer.
B3] The process of any one of T2]-A3] above, wherein the ethylene/alpha-olefin interpolymer and the second ethylene/alpha-olefin interpolymer are each, independently, selected from a telechelic ethylene/alpha-olefin interpolymer of the formula A¹L¹L²A2, as described herein, or an unsaturated ethylene/alpha-olefin interpolymer of the formula A¹L¹, as described herein, and further from an unsaturated ethylene/alpha-olefin interpolymer of the formula A¹L¹, as described herein.
C3] The process of any one of T2]-B3] above, wherein the ratio of the density of the ethylene/alpha-olefin to the density of the second ethylene/alpha-olefin is ≥0.80, or ≥0.85, or ≥0.90, or ≥0.92, or ≥0.94, or ≥0.96, or ≥0.98 or ≥1.0, and/or ≤1.25, or ≤1.20, or ≤1.18, or ≤1.16, or ≤1.14, or ≤1.12, or ≤1.11.
D3] The process of any one of T2]-C3] above, wherein the ratio of the total unsaturation of the ethylene/alpha-olefin to the total unsaturation of the second ethylene/alpha-olefin is ≥0.8, or ≥0.9, or ≥1.0, or ≥1.2, or ≥1.4, or ≥1.6, or ≥1.8 or ≥2.0, and/or ≤5.0, or ≤4.5, or ≤4.0, or ≤3.8, or ≤3.6, or ≤3.4, or ≤3.2, or ≤3.0, or ≤2.8, or ≤2.6, or ≤2.4, or ≤22.
E3] The process of any one of T2]-D3] above, wherein the ratio of the melt index (I2) of the ethylene/alpha-olefin to the melt index (I2) of the second ethylene/alpha-olefin is ≥0.8, or ≥6.0, or ≥8.0, or ≥10, or ≥15, or ≥20, or ≥25 or ≥30, and/or ≤100, or ≤80, or ≤60, or ≤50, or ≤45, or ≤40, or ≤35.
F3] The process of any one of T2]-E3] above, wherein the weight ratio of the ethylene/alpha-olefin to the second ethylene/alpha-olefin is ≥0.50, or ≥1.0, or ≥0.0, or ≥3.0, or ≥3.5, or ≥4.0, or ≥4.5, or ≥5.0, or ≥5.5 and/or ≤20, or ≤15, or ≤10, or ≤9.0, or ≤8.0, or ≤7.5, or ≤7.0, or ≤6.5, or ≤6.0.
G3] The process of any one of T2]-F3], wherein the component a comprises ≥80.0 wt %, or ≥85.0 wt %, or ≥90.0 wt %, or ≥95.0 wt %, or ≥98.0 wt %, or ≥99.0 wt %, or ≥99.2 wt %, or ≥99.4 wt %, or ≥99.6 wt %, or ≥99.7 wt % and/or ≤100.0 wt %, or ≤99.9 wt %, or ≤99.8 wt %, of the sum of the ethylene/alpha-olefin and the second ethylene/alpha-olefin, based on the weight of component a.
H3] The process of any one of A2]-S2], wherein the component a comprises ≥80.0 wt %, or ≥85.0 wt %, or ≥90.0 wt %, or ≥95.0 wt %, or ≥98.0 wt %, or ≥99.0 wt %, or ≥99.2 wt %, or ≥99.4 wt %, or ≥99.6 wt %, or ≥99.7 wt % and/or ≤100.0 wt %, or ≤99.9 wt %, or ≤99.8 wt %, of the ethylene/alpha-olefin, based on the weight of component a.
A4] The composition of any one of A]-W] above, or the process of any one of A2]-H3] above, wherein the ethylene/alpha-olefin of component a has a number average molecular weight Mn≥5,000, or ≥6,000, or ≥8,000, or ≥10,000, or ≥12,000, or ≥14,000, or ≥16,000, or ≥18,000, or ≥20,000 g/mol, and/or ≤120,000, or ≤100,000, or ≤80,000, or ≤70,000, or ≤65,000, or ≤60,000, or ≤58,000, or ≤56,000, or ≤54,000 g/mol.
B4] The composition of any one of A]-W] or A4] above, or the process of any one of A2]-H3] or A4] above, wherein the ethylene/alpha-olefin of component a has a weight average molecular weight Mn≥20,000, or ≥25,000, or ≥30,000, or ≥35,000, or ≥40,000, or ≥45,000 g/mol, and/or ≤150,000, or ≤145,000, or ≤140,000, or ≤135,000, or ≤130,000, or ≤125,000, or ≤120,000, or ≤115,000 g/mol.
C4] The composition of any one of A]-W], A4] or B4] above, or the process of any one of A2]-H3], A4] or B4] above, wherein the ethylene/alpha-olefin of component a has a molecular weight distribution MWD (=Mw/Mn) ≥1.80, or ≥1.85, or ≥1.90, or ≥1.95, or ≥2.00, or ≥2.05, or ≥2.10, and/or ≤5.00, or ≤4.50, or ≤4.00, or ≤3.50, or ≤3.20 or ≤3.00, or ≤2.90, or ≤2.80, or ≤2.70 or ≤2.60, or ≤2.50, or ≤2.45 or ≤2.40, or ≤2.35.
D4] The composition of any one of I]-W] or A4]-C4] above, or the process of any one of T2]-H3] or A4]-C4] above, wherein the ratio of the Mn of the ethylene/alpha-olefin to the Mn of the second ethylene/alpha-olefin interpolymer is 0.10, or ≥0.20, or ≥0.25, or ≥0.30, or ≥0.35 and/or ≤0.60, or ≤0.55, or ≤0.50, or ≤0.45, or ≤0.40.
E4] The composition of any one of I]-W] or A4]-D4] above, or the process of any one of T2]-H3] or A4]-D4] above, wherein the ratio of the Mw of the ethylene/alpha-olefin to the Mw of the second ethylene/alpha-olefin interpolymer is ≥0.20, or ≥0.25, or ≥0.30, or ≥0.35, or ≥0.40 and/or ≤0.70, or ≤0.65, or ≤0.60, or ≤0.55, or ≤0.50, or ≤0.45.
F4] The composition of any one of I]-W] or A4]-E4] above, or the process of any one of T2]-H3] or A4]-E4] above, wherein the ratio of the MWD of the ethylene/alpha-olefin to the MWD of the second ethylene/alpha-olefin interpolymer is ≥0.90, or ≥0.95, or ≥1.00, or ≥1.05 and/or ≤1.25, or ≤1.20, or ≤1.15, or ≤1.10.
G4] The composition of any one of A]-W] or A4]-F4] above, or the process of any one of A2]-H3] or A4]-F4] above, wherein, for the Structure I of component b, each of R1, R2, R3, and R4 is the same.
H4] The composition of any one of A]-W] or A4]-F4] above, or the process of any one of A2]-H3] or A4]-F4] above, wherein, for Structure I of component b, at least one of R1, R2, R3 and R4 is different than the others of R1, R2, R3 and R4.
I4] The composition of any one of A]-W] or A4]-F4] above, or the process of any one of A2]-H3] or A4]-F4] above, wherein, for Structure I of component b, each of R1, R2, R3 and R4 is, independently, selected from H or a C1-C5 alkyl, further H or a C₁-C₄ alkyl, further H or a C1-C3 alkyl, further H or a C1-C2 alkyl, further H or a methyl.
J4] The composition of any one of A]-W] or A4]-F4] above, or the process of any one of A2]-H3] or A4]-F4] above, wherein, for Structure I of component b, each of R1, R2, R3 and R4 is, independently, selected from a C1-C6 alkyl, further a C1-C5 alkyl, further a C1-C4 alkyl, further a C1-C3 alkyl, further a C1-C2 alkyl, further a methyl.
K4] The composition of any one of A]-W] or A4]-J4] above, or the process of any one of A2]-H3] or A4]-J4] above, wherein, for Structure I of component b, X is selected from CH₂, ether (—O—), carbonyl (—C(O)—), ester (—O—C(O)— or —C(O)—O—), amine (—N(R)—), or amide (—N(R)—C(O)— or —C(O)—N(R)—), and further CH₂, ether (—O—) or ester (—O—C(O)— or —C(O)—O—, and further ester (—O—C(O)— or —C(O)—O—).
L4] The composition of any one of A]-W] or A4]-K4] above, or the process of any one of A2]-H3] or A4]-K4] above, wherein, for Structure I of component b, R′ selected from a C1-C6 alkylene, further a C1-C5 alkylene, further a C1-C4 alkylene, further a C1-C3 alkylene, further a C1-C2 alkylene.
M4] The composition of any one of A]-W] or A4]-L4] above, or the process of any one of A2]-H3] or A4]-L4] above, wherein, for Structure I of component b, R″ selected from a C1-C6 alkylene, further a C1-C5 alkylene, further a C1-C4 alkylene, further a C1-C3 alkylene, further a C1-C2 alkylene, and further methylene.
N4] The composition of any one of A]-W] or A4]-L4] above, or the process of any one of A2]-H3] or A4]-L4] above, wherein, for Structure I of component b, R″ is not present. 04] The composition of any one of A]-W] or A4]-N4] above, or the process of any one of A2]-H3] or A4]-N4] above, wherein, for Structure I of component b, n≥2.
P4] The composition of any one of A]-W] or A4]-04] above, or the process of any one of A2]-H3] or A4]-04] above, wherein Structure I (component b) is selected from Structure IA.
Q4] The composition of any one of P4] above, or the process of any one of P2] above, wherein, for Structure IA, n is from 2 to 4, further from 2 or 3, further 2.
R4] The composition of 04] or P4] above, or the process of 04] or P4] above, wherein, for Structure IA, Y is selected from CR₄₋ₙ where n=1 to 4, OR₂₋ₙ where n=1 to 2, NR₃₋ₙ where n=1 to 3, a bifunctional C—C core as described herein, a phenyl core as described herein, a phenyl core substituted with ester as described herein, a phenyl core substituted with amide as described herein, and further from CR₄₋ₙ where n=1 to 4, OR₂₋ₙ where n=1 to 2, NR₃₋ₙ where n=1 to 3, a bifunctional C—C core as described herein, or a phenyl core as described herein, and further from CR₄₋ₙ where n=1 to 4, OR₂₋ₙ where n=1 to 2 or a bifunctional C—C core as described herein, and further from CR₄₋ₙ where n=1 to 4 or a bifunctional C—C core as described herein, and further from a bifunctional C—C core as described herein.
S4] The composition of R4] above, or the process of R4] above, wherein the bifunctional C—C core is selected from

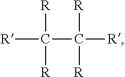

where each R′ represents the divalent R′ group in Structure IA above; and further each R of the C—C core is H.
T4] The composition of any one of P4]-S4] above, or the process of any one of P4]-S4] above, wherein, for Structure IA, each R is independently selected from an H, an unsubstituted hydrocarbyl, or a substituted hydrocarbyl, and further H or an unsubstituted hydrocarbyl, and further H or an alkyl, and further H or a C1-C5 alkyl.
U4] The composition of any one of P4]-T4] above, or the process of any one of P4]-T4] above, wherein Structure IA is Structure IA1 below:

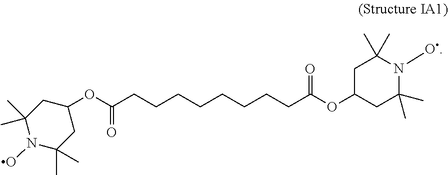

V4] The composition of any one of A]-W] or A4]-04] above, or the process of any one of A2]-H3] or A4]-04] above wherein Structure I (component b) is selected from Structure IB, which comprises sub-structure IB.
W4] The composition of V4] above, or the process of V4] above, wherein, for sub-structure IB, n≥10, or n≥20, or n≥50, or n≥100.
X4] The composition of V4] or W4] above, or the process of V4] or W4] above, wherein, for sub-structure IB, each R group is independently selected from an H, an unsubstituted hydrocarbyl, or a substituted hydrocarbyl, and further H or an unsubstituted hydrocarbyl, and further H or an alkyl, and further H or a C1-C5 alkyl.
Y4] The composition of any one of A]-W] or A4]-04] above, or the process of any one of A2]-H3] or A4]-04] above, wherein Structure I (component b) is selected from Structure IC, which comprises sub-structure IC.
Z4] The composition of Y4] above, or the process of Y4] above, wherein, for sub-structure IC, n≥10, or n≥20, or n≥50, or n≥100.
A5] The composition of Y4] or Z4] above, or the process of Y4] or Z4] above, wherein, for sub-structure IC, each R group is independently selected from an H, an unsubstituted hydrocarbyl, or a substituted hydrocarbyl, and further H or an unsubstituted hydrocarbyl, and further H or an alkyl, and further H or a C1-C5 alkyl.
B5] The composition of any one of Y4]-A5] above, or the process of any one of Y4]-A5] above, wherein, for sub-structure IC, each R′″ group is independently selected from an unsubstituted hydrocarbyl, or a substituted hydrocarbyl, and further an unsubstituted hydrocarbyl, and further an alkyl, and further a C1-C5 alkyl.
C5] The composition of any one of Y4]-B5] above, or the process of any one of Y4]-B5] above, wherein, for sub-structure IC, n≥3 and each end * (asterisk) forms a cyclic structure with the other end.
D5] The composition of any one of A]-W] or A4]-C5] above, or the process of any one of A2]-H3] or A4]-C5] above, wherein the molar ratio of the NO from the at least one Tempo compound (component b) to the peroxide (O—O) bonds from the at least one peroxide (component c) is ≥0.31, or ≥0.33, or ≥0.34, and/or ≤0.88, or ≤0.85, or ≤0.82, or ≤0.80, or ≤0.78, or ≤0.75, or ≤0.72, or ≤0.70, or ≤0.68, or ≤0.65, or ≤0.62, or ≤0.60, or ≤0.58.
E5] The composition of any one of A]-W] or A4]-D5] above, or the process of any one of A2]-H3] or A4]-D5] above, wherein component b is present in an amount ≥0.22, or ≥0.25, or ≥0.28, or ≥0.30, or ≥0.32, or ≥0.35, or ≥0.38, or ≥0.40, or ≥0.42 or ≥0.45 phr, and/or ≤0.88, or ≤0.85, or ≤0.82, or ≤0.80, or ≤0.78, or ≤0.75 phr, based on 100 parts of component a.
F5] The composition of any one of A]-W] or A4]-E5] above, or the process of any one of A2]-H3] or A4]-E5] above, wherein component c is present in an amount ≥0.40, or ≥0.45, or ≥0.50, or ≥0.55, or ≥0.60, or ≥0.62, or ≥0.65, or ≥0.68, or ≥0.70, or ≥0.72 or ≥0.74 phr, and/or ≤0.88, or ≤0.85, or ≤0.82, or ≤0.80, or ≤0.78 phr, based on 100 parts component a.
G5] The composition of any one of A]-W] or A4]-F5] above, or the process of any one of A2]-H3] or A4]-F5] above, wherein composition comprises ≥90.0 wt %, or ≥92.0 wt %, or ≥94.0 wt %, or ≥96.0 wt %, or ≥98.0 wt % or ≥98.1 wt %, or ≥98.2 wt % and/or ≤100.0 wt %, or ≤99.8 wt %, or ≤99.5 wt %, or ≤99.2 wt %, or ≤99.0 wt %, or ≤98.8 wt % of component a based on the weight of the composition.
H5] The composition of any one of A]-W] or A4]-G5] above, or the process of any one of A2]-H3] or A4]-G5] above, wherein the composition further comprises a crosslinking coagent (component d).
I5] The composition of H5] above, or the process of H5] above, wherein component d is present in an amount ≥0.05, or ≥0.10, or ≥0.15, or ≥0.20, or ≥0.22, or ≥0.25, or ≥0.28, or ≥0.30, or ≥0.32 or ≥0.35 phr, and/or 0.75, or ≤0.70, or ≤0.65, or ≤0.60, or ≤0.55, or ≤0.50, or ≤0.48, or ≤0.45, or ≤0.42, or ≤0.40 phr, based on 100 parts of component a.
J5] The composition of any one of A]-W] or A4]-I5] above, or the process of any one of A2]-H3] or A4]-I5] above, wherein the weight ratio of component c to component b is ≥0.50, or ≥0.60, or ≥0.70, or ≥0.80, or ≥0.85, or ≥0.90, or ≥0.95, or ≥1.0, and/or ≤5.0, or ≤4.5, or ≤4.0, or ≤3.8, or ≤3.5, or ≤3.2, or ≤3.0, or ≤2.8, or ≤2.5, or ≤2.2, or ≤2.0, or ≤1.9, or ≤1.8, or ≤1.7.
K5] The composition of any one of H5]-J5] above, or the process of any one of H5]-J5] above, wherein the weight ratio of component c to component d is ≥0.50, or ≥0.60, or ≥0.80, or ≥1.0, or ≥1.2, or ≥1.4, or ≥1.6, or ≥1.8, or ≥2.0, and/or ≤4.0, or ≤3.5, or ≤3.0, or ≤2.8, or ≤2.6, or ≤2.4, or ≤22.
L5] The composition of any one of A]-W] or A4]-K5] above, or the process of any one of A2]-H3] or A4]-K5] above, wherein the composition comprises ≤10.0 wt %, or ≤5.0 wt %, or ≤2.0 wt %, or ≤1.0 wt %, or ≤0.5 wt %, or ≤0.1 wt % of a filler, based on the weight of the composition; and further the composition does not comprise a filler.
M5] The composition of any one of A]-W] or A4]-L5] above, or the process of any one of A2]-H3] or A4]-L5] above, wherein composition comprises ≥90.0 wt %, or ≥94.0 wt %, or ≥96.0 wt %, or ≥97.0 wt % or ≥97.5 wt %, or ≥98.0 wt %, or ≥98.5 wt %, or ≥99.0 wt %, or ≥99.5 wt % and/or ≤100.0 wt %, or ≤99.9 wt %, or ≤99.8 wt %, or ≤99.7 wt % of the sum of components a, b and c, based on the weight of the composition.
N5] The composition of any one of A]-W] or A4]-M5] above, or the process of any one of A2]-H3] or A4]-M5] above, wherein composition comprises one Tempo compound for component b.
O5] The composition of any one of A]-W] or A4]-N5] above, or the process of any one of A2]-H3] or A4]-N5] above, wherein composition comprises one peroxide for component c.
P5] The composition of any one of A]-W] or A4]-05] above, or the process of any one of A2]-H3] or A4]-05] above, wherein the composition further comprises a polymer, different from the ethylene/alpha-olefin interpolymer of component a in one or more features, such as comonomer type, comonomer content, density, melt index (I2), total unsaturation, Mn, Mw, MWD, or any combination thereof, and further comonomer type, comonomer content, density, melt index (I2), total unsaturation, or any combination thereof.
Q5] The composition of any one of A]-W] or A4]-P5] above, or the process of any one of A2]-H3] or A4]-P5] above, wherein the composition has a (MH-ML) value MH≥4.0, or ≥4.1, or ≥4.2 dNm, and/or ≤10, or ≤8.0, or ≤6.0 dNm. See Test Methods section.
R5] The composition of any one of A]-W] or A4]-Q5] above, or the process of any one of A2]-H3] or A4]-Q5] above, wherein the ethylene/alpha-olefin interpolymer of component a (further copolymer) is a random interpolymer (further a random copolymer).
S5] The composition of any one of I]-W] or A4]-R5] above, or the process of any one of T2]-H3] or A4]-R5] above, wherein the second ethylene/alpha-olefin interpolymer (further copolymer) is a random interpolymer (further a random copolymer).
T5]A crosslinked composition formed from the composition of any one of A]-W] or A4]-S5] above, and further by thermally treating theses composition; or a crosslinked composition formed by the process of any one of A2]-H3] or A4]-S5] above.
U5] The crosslinked composition of T5] above, wherein the crosslinked composition has an H1714 value ≤0.010, or ≤0.005, or ≤0.002, or ≤0.001, where the H1714 value is determined by the FTIR-ATR method described herein.
V5] The crosslinked composition of T5] or U5] above, wherein the crosslinked composition has a D value ≤0.025, or ≤0.020, or ≤0.015, or ≤0.010, where the D value is determined by the FTIR-ATR method described herein.
W5] The crosslinked composition of any one of T5]-V5] above, wherein the crosslinked composition has an RD value ≤8%, or ≤6%, or ≤4%, or ≤2%, where the RD value is determined by the FTIR-ATR method described herein.
X5] The crosslinked composition of any one of T5]-W5] above, wherein the crosslinked composition has Finger Test rating of 3, as determined by the Finger Test described herein.
Y5] An article comprising at least one component formed from the composition of any one of A]-W] or A4]-S5] above, or formed by the process of any one of A2]-H3] or A4]-S5] above.
Z5] An article comprising at least one component formed from the crosslinked composition of any one of T5]-X5] above.
A6] The article of Y5] or Z5] above, wherein the article is an automotive part or a building material, a footwear component, or a PV film, and further an automotive part.
B6] The article of Y5] or Z5] above, wherein the article is a profile.

### Test Methods

### Moving Die Rheometer (MDR) Analysis

MDR cure properties of each composition (gum—see experimental section) was measured in accordance with ASTM D-5289, using an Alpha Technologies MDR 2000.

About a “4.5 g” sample was placed into the MDR sample holder. The MDR test was carried out at 180° C. over a period of 15 minutes, at an oscillation frequency of 100 CPM (1.67 Hz) and an oscillation angle of 0.5 degree (7% strain). The minimum torque (ML) and the maximum torque (MH) exerted by the MDR during the testing interval were reported in dNm. The difference between MH and ML is indicative of the extent of crosslinking, with the greater the difference reflecting a greater degree of crosslinking. The time it takes for torque to reach X % (for example, 90%) of the MH value, or the TX value (for example, T90), was reported in minutes. The time, from the start of the test, required for the torque value to increase one “dNm” value above the ML value is denoted as “TS1” and is recorded in minutes. The TS1 value is indicative of the time required for the crosslinking process to begin. A shorter time indicates a faster crosslinking initiation. One sample tested per composition.

### FTIR-ATR Analysis (Crosslinked Compositions)

The degradation of each hot air crosslinked composition was determined by FTIR-ATR analysis (Nicolet 5700 from Thermo Electron Corporation). Methylene groups (CH₂) signal around 1465 cm⁻¹, and are used as the industry standard. Carbonyl groups (C═O) signal around 1714 cm⁻¹, and are used to monitor the degradation degree. The height ratio between 1714 cm⁻¹ and 1465 cm⁻¹ represents the degradation degree as follows: D=H1714/H1465, where D is the degradation degree, H1714 is the IR peak height at 1714 cm⁻¹ (using 1845-1570 cm⁻¹ as a baseline), and H1465 is the IR peak height at 1465 cm⁻¹ (using 1540-1389 cm⁻¹ as a baseline) in the spectra of absorption mode. The relative degradation degree is calculated according to the formula as follows: RD=(D/D₀), where RD is the relative degradation degree, D is the degradation degree of the tested specimen, and D₀ is the degradation degree of control sample with peroxide, but without the Tempo compound.

For each analysis, a small sample of the hot air cured compression molded composition was used (see experimental section). The FTIR analysis used around a one micron penetration depth, and the outer surface of compression molded sample was exposed to the IR radiation (an area with a diameter of approx. 2 mm). One sample per composition examined.

Finger Test (Surface Tackiness) The hot air crosslinked compositions were tested for surface tackiness using a Finger Test. The Finger Test is a laboratory qualitative test method. Laboratory personnel use their fingers to touch the top surface of the crosslinked sample, and provide feedback regarding the surface tackiness of the sample, using the following criteria shown below in Table A. One sample was tested per composition.

TABLE A
Finger Test rating

| Tackiness Rating | Description |
|---|---|
| 3 | Surface not tacky |
| 2 | Surface a little tacky |
| 1 | Surface very tacky like an adhesive tape |

### ¹H NMR Method

Sample Preparation: Each sample was prepared by adding approximately 130 mg of sample to 3.25 g of a “50/50 by weight tetrachlorethane-d2/perchloroethylene (TCE-d2/PCE) with 0.001M Cr(AcAc)₃,” in a NORELL 1001-7, 10 mm, NMR tube. The sample was purged by bubbling N₂ through the solvent, via a pipette inserted into the tube, for approximately five minutes to prevent oxidation. The tube was then capped and sealed with TEFLON tape, before heating and vortex mixing at 115° C. to achieve a homogeneous solution.

Data Acquisition Parameters and Data Analysis: ¹H NMR was performed on a Bruker AVANCE 600 MHz spectrometer, equipped with a Bruker high-temperature CryoProbe, with a sample temperature of 120° C. Two experiments were run to obtain spectra, a control spectrum to quantitate the total polymer protons, and a double presaturation experiment, which suppresses the intense peaks associated with the polymer chains, and enables high sensitivity spectra for quantitation of the end-groups. The control was run with ZG pulse, 16 scans, AQ 1.82 s, D₁ (relaxation delay) 14 s. The double presaturation experiment was run with a modified pulse sequence, lclprf2.zz, 64 scans, AQ 1.82 s, D₁ (presaturation time) 2 s, D13 (relaxation delay) 12 s. Unsaturation measurements were made according to the following method. The area under the resonance from the polymer chains (i.e., CH, CH₂, and CH₃ in the polymers) was measured from the spectrum acquired during first experiment (the control spectrum), described above.

The unsaturation was analyzed with the method in Reference 3 noted below.
Reference 1: Z. Zhou, R. Kuemmerle, J. C. Stevens, D. Redwine, Y. He, X. Qiu, R. Cong, J. Klosin, N. Montan\tilde{e}z, G. Roof, Journal of Magnetic Resonance, 2009, 200, 328.
Reference 2: Z. Zhou, R. Kummerle, X. Qiu, D. Redwine, R. Cong, A. Taha, D. Baugh, B. Winniford, Journal of Magnetic Resonance: 187 (2007) 225. Reference 3: Z. Zhou, R. Cong, Y. He, M. Paradkar, M. Demirors, M. Cheatham, W. deGroot, Macromolecular Symposia, 2012, 312, 88.

The peak areas for each type of observed unsaturation (i.e., vinyl, vinylidene, vinylene and trisubstituted) was measured from the spectrum acquired during the second (presaturation) experiment described above. Both spectra were normalized to the solvent peak area. Moles of respective unsaturation were calculated by dividing the area under the unsaturation resonance by the number of protons contributing to that resonance. Moles of carbons in the polymers were calculated by dividing the area under the peaks for polymer chains (i.e., CH, CH₂, and CH₃ in the polymers) by two. The amount of total unsaturation (sum of the above unsaturations) was then expressed as a relative ratio of moles of total unsaturation to the moles of carbons in the polymers, with expression of the number of unsaturation per 1000 Carbon (per 1000 C). Results are the same within <5% relative.

### Melt Index

The melt index 12 (or MI) of an ethylene-based polymer or blend (as used herein) is measured in accordance with ASTM D-1238, condition 190° C./2.16 kg. The melt flow rate MFR of a propylene-based polymer is measured in accordance with ASTM D-1238, condition 230° C./2.16 kg.

### Polymer Density

ASTM D4703 is used to make a polymer plaque for density analysis. ASTM D792, Method B, is used to measure the density of each polymer.

### Gel Permeation Chromatography—Ethylene-Based Polymers

The chromatographic system consists of a PolymerChar GPC-IR (Valencia, Spain) high temperature GPC chromatograph, equipped with an internal infra-red detector (IR5). The autosampler oven compartment is set at 160° C., and the column compartment is set at 150° C. The columns are four AGILENT “Mixed A” 30 cm, 20-micron linear mixed-bed columns. The chromatographic solvent is 1,2,4-trichlorobenzene, which contains 200 ppm of butylated hydroxytoluene (BHT). The solvent source is nitrogen sparged. The injection volume is 200 microliters, and the flow rate is 1.0 milliliters/minute.

Calibration of the GPC column set is performed with 21 narrow molecular weight distribution polystyrene standards, with molecular weights ranging from 580 to 8,400,000 g/mol, and which are arranged in six “cocktail” mixtures, with at least a decade of separation between individual molecular weights. The standards are purchased from Agilent Technologies. The polystyrene standards are prepared at “0.025 grams in 50 milliliters” of solvent, for molecular weights equal to, or greater than, 1,000,000, and at “0.05 grams in 50 milliliters” of solvent, for molecular weights less than 1,000,000. The polystyrene standards are dissolved at 80° C., with gentle agitation, for 30 minutes. The polystyrene standard peak molecular weights are converted to polyethylene molecular weights using Equation 1 (as described in Williams and Ward, J. Polym. Sci., Polym. Let., 6, 621 (1968)):

M_{polyethylene}=A×(M_{polystyrene})^{B} (EQ1),

where M is the molecular weight, A has a value of 0.4315 and B is equal to 1.0.

A fifth order polynomial is used to fit the respective polyethylene-equivalent calibration points. A small adjustment to A (from approximately 0.375 to 0.445) is made to correct for column resolution and band-broadening effects, such that linear homopolymer polyethylene standard is obtained at 120,000 Mw. The total plate count of the GPC column set is performed with decane (prepared at “0.04 g in 50 milliliters” of TCB, and dissolved for 20 minutes with gentle agitation.) The plate count (Equation 2) and symmetry (Equation 3) are measured on a 200 microliter injection according to the following equations:

Plate Count 5.54*[(RV_{Peak Max})/(Peak Width at ½ height)]² (EQ2),

where RV is the retention volume in milliliters, the peak width is in milliliters, the peak max is the maximum height of the peak, and 2 height is 12 height of the peak maximum; and

$$Symmetry = \frac{( Rear Peak {RV}_{one tenth height} - {RV}_{Peak ma x} )}{( {RV}_{Peak ma x} - Front Peak {RV}_{one tenth height} )}$$

(EQ3), where RV is the retention volume in milliliters, and the peak width is in milliliters, Peak max is the maximum position of the peak, one tenth height is 1/10 height of the peak maximum, and where rear peak refers to the peak tail at later retention volumes than the peak max, and where front peak refers to the peak front at earlier retention volumes than the peak max. The plate count for the chromatographic system should be greater than 18,000, and symmetry should be between 0.98 and 1.22.

Samples are prepared in a semi-automatic manner with the PolymerChar “Instrument Control” Software, wherein the samples are weight-targeted at “2 mg/ml,” and the solvent (contains 200 ppm BHT) is added to a pre nitrogen-sparged, septa-capped vial, via the PolymerChar high temperature autosampler. The samples are dissolved for two hours at 160° C. under “low speed” shaking.

The calculations of Mn_{(GPC)}, Mw_{(GPc)}, and Mz_{(GPC)} are based on GPC results using the internal IR5 detector (measurement channel) of the PolymerChar GPC-IR chromatograph according to Equations 4-6, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1. Equations 4-6 are as follows:

$${Mn}_{( GPC )} = \frac{{\sum }^{i} {IR}_{i}}{{\sum }^{i} ( {IR}_{i} / {M}_{{polyethylene}_{i}} )} , \qquad ( EQ 4 )$$

$${Mw}_{( GPC )} = \frac{{\sum }^{i} ( {IR}_{i} * {M}_{{polyethylene}_{i}} )}{{\sum }^{i} {IR}_{i}} , and \qquad ( EQ 5 )$$

$${Mz}_{( GPC )} = \frac{{\sum }^{i} ( {IR}_{i} * {M}_{{polyethylene}_{i}}^{2} )}{{\sum }^{i} ( {IR}_{i} * {M}_{{polyethylene}_{i}} )} . \qquad ( EQ 6 )$$

In order to monitor the deviations over time, a flowrate marker (decane) is introduced into each sample, via a micropump controlled with the PolymerChar GPC-IR system. This flowrate marker (FM) is used to linearly correct the pump flowrate (Flowrate(nominal)) for each sample, by RV alignment of the respective decane peak within the sample (RV(FM Sample)), to that of the decane peak within the narrow standards calibration (RV(FM Calibrated)). Any changes in the time of the decane marker peak are then assumed to be related to a linear-shift in flowrate (Flowrate(effective)) for the entire run. To facilitate the highest accuracy of a RV measurement of the flow marker peak, a least-squares fitting routine is used to fit the peak of the flow marker concentration chromatogram to a quadratic equation. The first derivative of the quadratic equation is then used to solve for the true peak position. After calibrating the system, based on a flow marker peak, the effective flowrate (with respect to the narrow standards calibration) is calculated as Equation 7:

Flowrate(effective)=Flowrate(nominal)*(RV(FM Calibrated)/RV(FM Sample)) (EQ7).

Processing of the flow marker peak is done via the PolymerChar GPCOne™ Software. Acceptable flowrate correction is such that the effective flowrate is within +/−0.7% of the nominal flowrate.

### EXPERIMENTAL

### Commercial Polymers and Additives

Commercial and experimental polymer and additives are listed below in Table 1.

TABLE 1
Commercial Polymers, Experimental Polymers and Additives

| Ingredient | | Chemical Description | Source |
|---|---|---|---|
| Base polymer | EO Mono 5 | EO monounsaturated (A¹L¹), density = 0.868 g/cm³, | The Dow Chemical |
| | | MI = 1.1 g/10 min (190° C./2.16 kg) | Company (Dow) |
| | | Vinyl/1000C = 0.08, total unsaturation/1000C = 0.29 | |
| Base polymer | EO Mono 3 | EO monounsaturated (A¹L¹), density = 0.871 g/cm³, | Dow |
| | | MI = 33.4 g/10 min (190° C./2.16 kg) | |
| | | Viny1/1000C = 0.37, total unsaturation/1000C = 0.60 | |
| Base polymer | ENGAGE 8100 | Ethylene/octene copolymer (EO POE); | Dow |
| | | Density = 0.87 g/cm³; | |
| | | MI = 1 g/10 min (at 190° C./2.16 kg) | |
| Base polymer | ENGAGE 8407 | Ethylene/octene copolymer (EO POE); | Dow |
| | | Density = 0.87 g/cm³; | |
| | | MI = 30 g/10 min (at 190° C./2.16 kg) | |
| Peroxide | LUPEROX 101 | 2,5-Bis-(tert-butylperoxy)-2,5-dimethylhexane; | Sigma-Aldrich |
| | | MW = 290.4 g/mole | |
| Coagent | TAIC | Triallyl isocyanurate | Fangruida |
| | | | Chemicals Co., Ltd. |
| Tempo | | Bis-(2,2,6,6-tetramethyl-l-piperidinyloxy-4-yl) | Suqian Unitechem |
| compound | | sebacate; MW = 510.7 g/mole | Group |

The 1H NMR and GPC characterization results of the commercial and experimental polymers are listed below in Tables 2A and 2B, respectively.

TABLE 2A
¹H NMR Results

| | I2 | Total | Viny1/1000C | Vinylidene/1000C | Vinylene/1000C | Trisub/1000C |
|---|---|---|---|---|---|---|
| Name | dg/min | Unsats/1000C | (% Viny1) | (% Vinylidene) | (% Vinylene) | (% Trisub) |
| ENGAGE | 30 | 0.078 | 0.046 | 0.012 | 0.014 | 0.006 |
| 8407 | | | (58.97%) | (15.38%) | (17.95%) | (7.69%) |
| ENGAGE | 1 | 0.066 | 0.038 | 0.008 | 0.014 | 0.006 |
| 8100 | | | (57.58%) | (12.12%) | (21.21%) | (9.09%) |
| EO Mono 3* | 33.4 | 0.596 | 0.371 | 0.158 | 0.062 | 0.005 |
| | | | (62.25%) | (26.51%) | (10.40%) | (0.84%) |
| EO Mono 5* | 1.1 | 0.294 | 0.080 | 0.061 | 0.145 | 0.008 |
| | | | (27.21%) | (20.75%) | (49.32%) | (2.72%) |

Note, the % of a particular unsaturation (% pu) = [(amt. pu/1000C)/(amt. total unsat./1000C)] × 100; where the % pu = % vinyl, % vinylidene, % vinylene, or % trisub.
*EO = Ethylene/octene copolymer.

TABLE 2B
GPC Results

| | Mn (g/mol) | Mw (g/mol) | MWD (Mw/Mn) |
|---|---|---|---|
| ENGAGE 8407 | 23100 | 49338 | 2.14 |
| ENGAGE 8100 | 47700 | 105400 | 2.21 |
| EO Mono 3 | 21332 | 49277 | 2.31 |
| EO Mono 5 | 53722 | 114965 | 2.14 |

### Polymer Synthesis—EO Mono 3 and EO Mono 5

### Catalysts

CAT 2 may by prepared according to the teachings of WO 2011/102989 A1, and has the following structure:

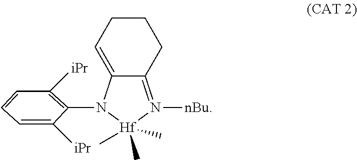

### Polymerization of EO Mono 3 and EO Mono 5

Continuous solution polymerizations of EO Mono 3 (A¹L¹) and EO Mono 5 (A¹L¹) were each carried out in a computer controlled autoclave reactor, equipped with an internal stirrer. Purified mixed alkanes solvent (ISOPAR E available from ExxonMobil), monomers, and molecular weight regulator (hydrogen or chain transfer agent) were supplied to a 3.8 L reactor, equipped with a jacket for temperature control. The solvent feed to the reactor was measured by a mass-flow controller. A variable speed diaphragm pump controlled the solvent flow rate and pressure to the reactor. At the discharge of the pump, a side stream was taken to provide flush flows for the procatalyst, activator, and chain transfer agent (CTA) (catalyst component solutions) injection lines. These flows were measured by mass flow meters, and controlled by control valves. The remaining solvent was combined with monomers and hydrogen, and fed to the reactor. The temperature of the solvent/monomer solution was controlled by use of a heat exchanger, before entering the reactor. This stream entered the bottom of the reactor. The catalyst component solutions were metered using pumps and mass flow meters, and were combined with the catalyst flush solvent, and introduced into the bottom of the reactor. The reactor was liquid full at “500 psig” with vigorous stirring. Polymer was removed through exit lines at the top of the reactor. All exit lines from the reactor were steam traced and insulated. The product stream was then heated at 230° C., by passing through a post reactor heater (PRH), where beta-H elimination of polymeryl-Al took place. A small amount of isopropyl alcohol was added, along with any stabilizers or other additives, after the PRH, and before devolatilization. The polymer product was recovered by extrusion, using a devolatilizing extruder. The polymerization process conditions and results prior to the post reactor heating (PRH) are listed in Tables 3A and 3B.

Abbreviations in the tables are explained as follows: “Co.” stands for comonomer; “sccm” stands for standard cm³/min; “T” refers to temperature; “Cat” stands for Procatalyst; “CAT 2” stands for Procatalyst (CAT 2) as shown above; “CoCAT-1” refers to the cocatalyst defined in Table 3B (footnote); “CTA“stands for chain transfer agent”; “Poly Rate” stands for polymer production rate; “Conv” stands for percent ethylene conversion in reactor; “Eff”.” Stands for efficiency, kg polymer/mg catalyst metal; “TEA” stands for triethylaluminum, and “C2” stands for ethylene.

TABLE 3A
Polymerization Conditions

| | | | | | | | | CAT | CAT |
|---|---|---|---|---|---|---|---|---|---|
| | C2 | Co. | Co. | Solv. | H2 | T | | Conc. | flow |
| | lbs/hr | Type | lbs/hr | lbs/hr | sccm | ° C. | Cat. | ppm metal* | lbs/hr |
| EO Mono 3 | 2.85 | 1-octene | 5.6 | 36.2 | 0 | 125 | CAT 2 | 124.8 | 0.097 |
| EO Mono 5 | 2.90 | 1-octene | 6.2 | 36.0 | 0 | 140 | CAT 2 | 63.0 | 0.264 |

*The “ppm” amount based on the weight of the respective feed solution.

TABLE 3B
Polymerization Conditions

| | CTA* | CTA | | CoCAT | CoCAT | Poly. | | | |
|---|---|---|---|---|---|---|---|---|---|
| | conc. | Flow | | Conc. | Flow | Rate | Conv. | Solids | |
| | Ppm*** | lbs/hr | CoCAT** | ppm*** | lbs/hr | lbs/hr | % | % | Eff. |
| EO Mono 3 | 9820 | 0.580 | CoCAT-1 | 120 | 0.082 | 3.95 | 85 | 10.1 | 0.325 |
| EO Mono 5 | 4459 | 0.149 | CoCAT-1 | 1230 | 0.109 | 4.10 | 85 | 10.5 | 0.247 |

*CTA for EO Mono 3 and EO Mono 5 was TEA.
**CoCAT-1 is a mixture of methyldi(C₁₄₋₁₈ alkyl)ammonium salts of tetrakis(pentafluorophenyl)borate, prepared by reaction of a long chain trialkylamine (ARMEEN M2HT, available from Akzo-Nobel, Inc.), HCl and Li[B(C₆F₅)₄], substantially as disclosed in U.S. Pat. No. 5,919,983, Ex. 2 (no further purification performed) (Boulder Scientific).
***The “ppm” amount based on the weight of the respective feed solution.

### Preparation of Compositions and Evaluations of the Same

### Brabender Mixing and Compression Molding and Thermal Treatment in Convection Oven

The compositions are shown in Table 4A and Table 4B below. For each composition listed, the base polymer (pellets) was first soaked with the solution of the peroxide LUPEROX 101 and the coagent TAIC in a fluorinated bottle (from Shanghai Heqi Glassware Co., Ltd), and the bottle was placed on a roller (Model NO: 88881004, DESC: Bottle/Tube Roller from Thermo SCIENTIFIC) equilibrated at 40° C., and the bottle and contents were rotated (360 degrees along the horizontal axis of the bottle, 70 rpm) for 24 hours, to form soaked polymer pellets.

The soaked pellets (entire mixture, no filtering, 37 grams) were loaded into a Brabender mixer (50 mL cavity—mixing chamber) set at a temperature of 105° C., and with a rotor speed of 40 rpm. The soaked pellets were mixed and homogeneously heated for around two minutes, to form a polymer melt. Afterwards, the Tempo compound was weighed and gradually added into the mixing chamber. The mixing was then continued for another six minutes, and the temperature of the melt was around 110° C. A final gum (pre-crosslinked, gel content <5 wt %) was formed. A sample of the final gum was analyzed by MDR, and the results are shown in Table 4A and Table 4B below.

The gum from Brabender mixing was compression molded into a plaque in a “1.0 mm thick” mold. The gum (14 grams) was preheated at 110° C. for three minutes, and then degassed (repeated compression at 5 MPa and release, for six times), followed by another two minutes pressing at a pressure of 10 MPa, at 110° C. The plaque (15 cm×7 cm×1 mm, pre-crosslinked) was taken out from the mold after ramping the mold temperature to room temperature. The obtained plaque (pre-crosslinked, gel content ≤5 wt %) was further cut into the required shape and size for oven curing (⅓ mass of plaque used for thermal treatment in a hot air convection oven).

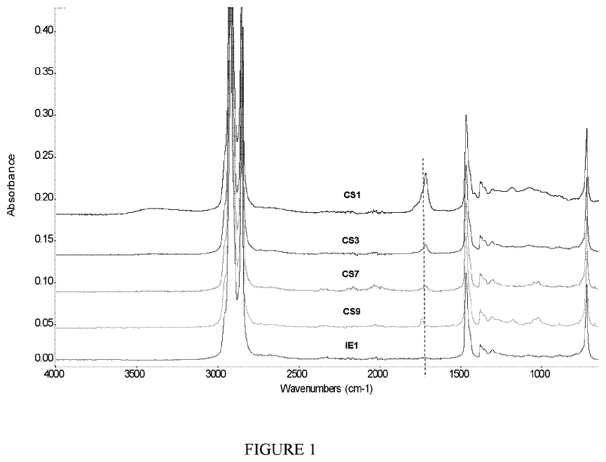

A hot air convection oven was preheated and equilibrated at 200° C. under ambient atmosphere. As discussed above, the compression molded composition was transferred into the oven, with hot air convection, and kept at 200° C., for 10 minutes, for crosslinking. The crosslinked composition was then removed and cooled to room temperature. The crosslinked composition was analyzed by the Finger Test and by FTIR-ATR, each discussed above, to evaluate the surface tackiness and surface degradation. Results are shown in Table 4A and Table 4B below. FTIR-ATR profiles are shown in FIG. 1.

### Results

MDR, FTIR-ATR and Finger Test results are shown in Table 4A and Table 4B. As seen in Table 4B, the inventive compositions (IE1 and IE2) have sufficient crosslinking (“MH-ML” values of 5.06 and 4.20), low amounts of degradation (D values of 0.010 and 0; RD values of 2% and 0), and a tack-free crosslinked surface (rating of 3 for each). These compositions cure well in air, and since they lack a high filler loading, are light weight and less conductive as compared to highly filled EPDM vulcanizates.

Comparative composition CS3, with a “molar ratio of nitroxide NO to peroxide bonds” of 0.19, produced a tacky crosslinked surface (rating of 2) and higher D (0.102) and RD (24%) values as compared to the inventive compositions. CS1 and CS4 in Table 4B were the control compositions, which did not include the Tempo compound. As shown in Table 4B, they each had a high degradation degree D and very tacky surface (rating of 1 for each). With the addition of the Tempo compound, the degree of surface degradation was decreased, relative to the respective control composition, as seen by the decrease of in the D value and by the higher Finger Test rating for some of the compositions. It is also noted that for the comparative compositions CS5 through CS9, higher levels of peroxide and coagent (TAIC) were needed for sufficient crosslinking. However, the same or higher amounts of the Tempo compound, in these compositions, did not result in a tack-free surface. For comparative composition CS9, much more Tempo compound (1.6 phr) was used, but the surface was still tacky, although the degradation degree (D), based on H1714, was relatively small at 0.020. As seen in FIG. 1, another peak at 1737 cm⁻¹ was observed for CS9. This peak can be attributed to other polar functional groups created on the surface, perhaps due to migration issues. These polar functional groups at 1737 cm⁻¹ can increase surface tackiness as well.

As seen in Table 4A, the high ratio of nitroxide NO to peroxide bonds (CS10) resulted in a very low MH and “MH-ML” values (i.e., poor curing). A high Tempo compound loading (CS11) and a low Tempo compound loading (CS12) also resulted in low MH and “MH-ML” values. Each of these three examples showed a slightly tacky surface. CS10 and CS11 each had a peak at 1737 cm⁻¹ (other polar functional group) in FTIR-ATR spectra, which also contributes to surface tackiness to some extent.

TABLE 4A
Comparative Compositions and Properties (First and Second Aspects)

| Formulation (phr, relative to 100 parts polymer(s) | CS10 | CS11 | CS12 |
|---|---|---|---|
| EO Mono 3/EO Mono 5 = 85/15 (wt/wt) | 100 | 100 | 100 |
| Peroxide LUPEROX 101 | 0.45 | 0.75 | 0.20 |
| TAIC | 0.375 | 0.375 | 0.375 |
| Tempo Compound | 0.85 | 1.15 | 0.15 |
| Moles of NO• from the Tempo Compound | 0.00333 | 0.00450 | 0.000587 |
| Moles of peroxide bonds from LUPEROX 101 | 0.00310 | 0.00516 | 0.00138 |
| Molar ratio of nitroxide NO• to peroxide bonds | 1.07 | 0.87 | 0.43 |
| MH (dNm) | 0.31 | 1.75 | 2.39 |
| ML (dNm) | 0.04 | 0.04 | 0.03 |
| MH − ML (dNm) | 0.27 | 1.71 | 2.36 |
| T90 (min) | 10.54 | 9.04 | 6.67 |
| TS1 (min) | n.a. | 6.25 | 3.37 |
| H₁₇₁₄ | 0.0043 | 0.006 | 0.002 |
| H₁₄₆₅ | 0.0761 | 0.096 | 0.098 |
| D | 0.057 | 0.063 | 0.020 |
| RD | 13.3% | 14.7% | 4.8% |
| H₁₇₃₇ | 0.013 | 0.019 | 0 |
| D1 | 0.171 | 0.198 | 0.000 |
| Finger Test Rating | 2 | 2 | 2 |

TABLE 4B
Inventive and Comparative Compositions and Properties

| Formulation (phr) | CS1 | CS2 | CS3 | IE1 | IE2 | CS4 |
|---|---|---|---|---|---|---|
| EO Mono 3/EO Mono 5 = 85/15 (wt/wt) | 100 | 100 | 100 | 100 | 100 | |
| 12 (MI) = 19.7 g/10 min | | | | | | |
| ENGAGE8407/ENGAGE8100 = 87/13 | | | | | | 100 |
| (wt/wt), 12 (MI) = 17.8 g/10 min | | | | | | |
| Peroxide LUPEROX 101 | 0.75 | 0.75 | 0.75 | 0.75 | 0.75 | 1.60 |
| TAIC | 0.375 | 0.375 | 0.375 | 0.375 | 0.375 | 0.800 |
| Tempo Compound | 0 | 0.075 | 0.25 | 0.45 | 0.75 | 0 |
| Moles of NO· from the Tempo | 0 | 0.000294 | 0.000979 | 0.001762 | 0.002937 | 0 |
| Compound* | | | | | | |
| Moles of peroxide bonds from | 0.005165 | 0.005165 | 0.005165 | 0.005165 | 0.005165 | 0.01102 |
| LUPEROX 101* | | | | | | |
| Molar ratio of nitroxide | 0 | 0.057 | 0.189 | 0.341 | 0.568 | 0 |
| NO· to peroxide bonds | | (0.06) | (0.19) | (0.34) | (0.57) | |
| MH (dNm) | 5.98 | 5.57 | 5.46 | 5.09 | 4.23 | 5.16 |
| ML (dNm) | 0.04 | 0.03 | 0.04 | 0.03 | 0.03 | 0.04 |
| MH-ML (dNm) | 5.94 | 5.54 | 5.42 | 5.06 | 4.20 | 5.12 |
| T90 (min) | 4.64 | 4.37 | 5.81 | 6.39 | 8.32 | 6.78 |
| TS1 (min) | 0.73 | 0.96 | 1.27 | 1.58 | 2.52 | 0.59 |
| H₁₇₁₄ | 0.039 | 0.032 | 0.01 | 0.001 | 0 | 0.045 |
| H₁₄₆₅ | 0.092 | 0.091 | 0.098 | 0.101 | 0.102 | 0.088 |
| D | 0.424 | 0.352 | 0.102 | 0.010 | 0.000 | 0.511 |
| RD | 100% | 8 3% | 24% | 2% | 0 | 100% |
| Finger Test Rating | 1 | 1 | 2 | 3 | 3 | 1 |
| | | CS5 | CS6 | CS7 | CS8 | CS9** |

| | | | | | |
|---|---|---|---|---|---|
| EO Mono 3/EO Mono 5 = 85/15 (wt/wt) | | | | | |
| 12 (MI) = 19.7 g/10 min | | | | | |
| ENGAGE8407/ENGAGE8100 = 87/13 | 100 | 100 | 100 | 100 | 100 |
| (wt/wt), 12 (MI) = 17.8 g/10 min | | | | | |
| Peroxide LUPEROX 101 | 1.60 | 1.60 | 1.60 | 1.60 | 1.60 |
| TAIC | 0.800 | 0.800 | 0.800 | 0.800 | 0.800 |
| Tempo Compound | 0.075 | 0.25 | 0.45 | 0.75 | 1.60 |
| Moles of NO· from the Tempo | 0.00029 | 0.000979 | 0.00176 | 0.00294 | 0.006266 |
| Compound* | | | | | |
| Moles of peroxide bonds from | 0.01102 | 0.011019 | 0.01102 | 0.01102 | 0.011019 |
| LUPEROX 101* | | | | | |
| Molar ratio of nitroxide | 0.027 | 0.089 | 0.160 | 0.266 | 0.568 |
| NO· to peroxide bonds | (0.03) | (0.09) | (0.16) | (0.27) | (0.57) |
| MH (dNm) | 4.81 | 5.15 | 4.97 | 4.87 | 4.89 |
| ML (dNm) | 0.04 | 0.04 | 0.04 | 0.04 | 0.03 |
| MH-ML (dNm) | 4.77 | 5.11 | 4.93 | 4.83 | 4.86 |
| T90 (min) | 6.38 | 5.99 | 6.86 | 6.8 | 8.03 |
| TS1 (min) | 0.66 | 0.75 | 0.91 | 1.17 | 2.07 |
| H₁₇₁₄ | 0.034 | 0.019 | 0.005 | 0.003 | 0.002 |
| H₁₄₆₅ | 0.09 | 0.096 | 0.098 | 0.097 | 0.098 |
| D | 0.378 | 0.198 | 0.051 | 0.031 | 0.020 |
| RD | 74% | 39% | 10% | 6% | 4% |
| Finger Test Rating | 1 | 1 | 2 | 2 | 2 |

*Moles of NO· from the Tempo Compound = {[Bis-Tempo Compound weight/(MW = 510.7)] * 2}; *Moles of peroxide bonds from LUPEROX 101 = {[LUPEROX 101 weight/(MW = 290.4)] * 2}.
**CS9, another peak at 1737 cm-1 (other polar functional group) appeared in FTIR-ATR spectrum, which also contributed to surface tackiness, and the degradation degree D1 and relative degradation degree RD1 based on H1737 were calculated: D1 = 0.092 and RD1 = 18%.
Note,
the Density Equation for a blend (for example, the 85/15 blend) is as follows, where Wa and WE are the respective weight fractions of the blend components, and pₐ and p_{b} are the respective densities of the blend components:
$\frac{1}{ρ} = \frac{{w}_{a}}{{ρ}_{a}} + \frac{{w}_{b}}{{ρ}_{b}} .$ Note,
the equation to determine “total unsaturation/1000 C.” for a blend (for example, the 85/15 blend) is as follows, where Wₐ and W_{b} are the respective weight fractions of the blend components.
Unsatₐ and Unsat_{b} are the respective “total unsaturation/1000 C.” of the blend components: Unsat = wₐUnsatₐ + w_{b}Unsat_{b}^{.}

1. A composition comprising the following components a) through c):
a) at least one ethylene/alpha-olefin interpolymer that comprises the following properties: i) a density 0.855 to 0.900 g/cc and ii) a total unsaturation ≥0.20/1000 C,
b) at least one Tempo compound of Structure I) below; and
c) at least one peroxide;
and wherein the molar ratio of the NO· from the at least one Tempo compound (component b) to the peroxide (O—O) bonds from the at least one peroxide (component c) is from 0.30 to 0.90;
and wherein component b is present in an amount from 0.20 to 0.90 phr, based on 100 parts of component a; and
wherein Structure I is selected from Structure IA, Structure IB or Structure IC, each as follows:
Structure IA is 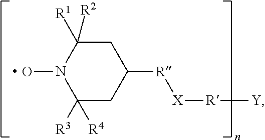
wherein n is an integer ≥1;
R1, R2, R3 and R4 are each independently selected from H or a C1-C18 alkyl;
X is selected from CH₂, ether (—O—), thioether (—Sₘ—, where m≥1), carbonyl (—C(O)—), ester (—O—C(O)— or —C(O)—O—), amine (—N(R)—), amide (—N(R)—C(O)— or —C(O)—N(R)—), urethane (—O—C(O)—NH— or —NH—C(O)—O—), carbamide (—NH—C(O)—NH—), or imide (—C(O)—N(R)—C(O)—);
R′ is selected from a C1-C30 alkylene;
R″ may or may not be present, and if present, R″ is selected from a C1-C30 alkylene;
Y is selected from CR₄₋ₙ where n=1 to 4, OR₂₋ₙ where n=1 to 2, NR₃₋ₙ where n=1 to 3, SR₂₋ₙ where n=1 to 2, PR₃₋ₙ where n=1 to 3, PR₅₋ₙ where n=1 to 5, SiR₄₋ₙ where n=1 to 4, a bifunctional C—C core, a phenyl core, a phenyl core substituted with ester, a phenyl core substituted with amide, a tris-isocyanurate core, or a melamine core; and
wherein the bifunctional C—C core is selected from the following structures, where each R′ represents the divalent R′ group in Structure IA above: 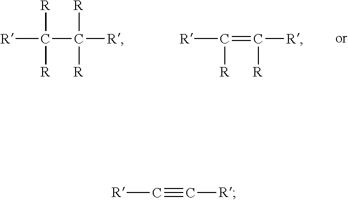
wherein the phenyl core is selected from the following structures, where each R′ represents the divalent R′ group in Structure IA above: 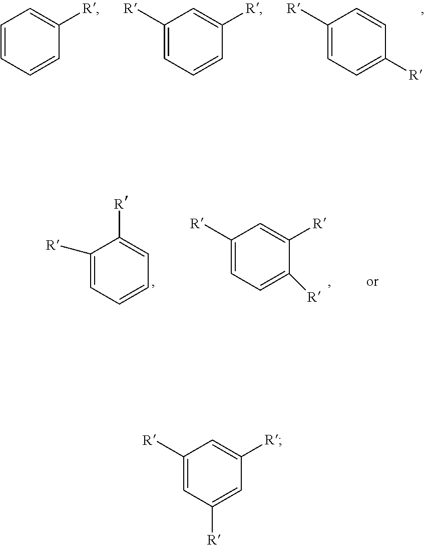
the phenyl core substituted with ester is selected from the following structures, where each R′ represents the divalent R′ group in Structure IA above: 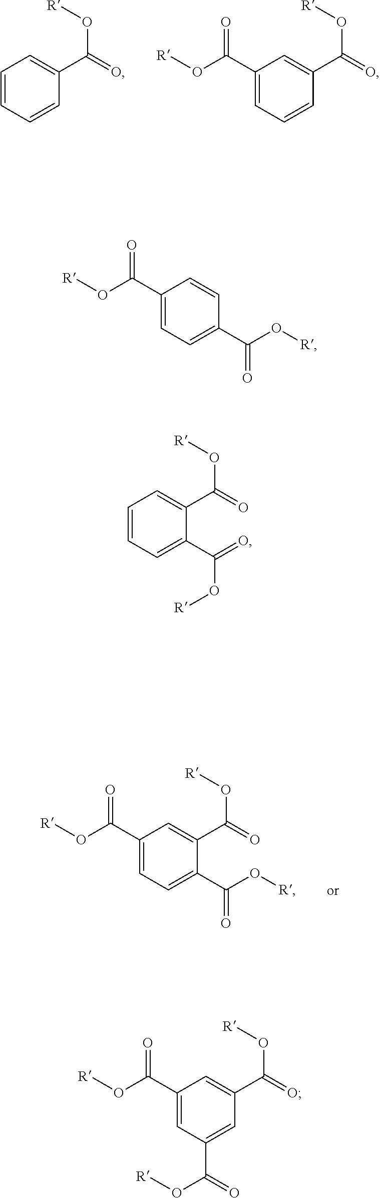
the phenyl core substituted with amide is selected from the following structures, where each R′ represents the divalent R′ group in Structure IA above: 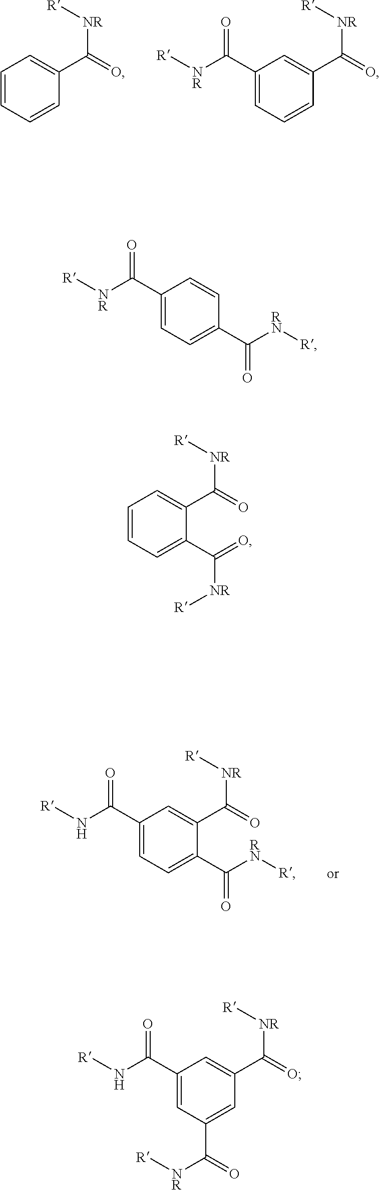
the tris-isocyanurate core is as follows, where each R′ represents the divalent R′ group in Structure IA above; 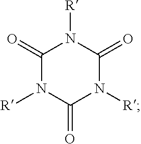
the melamine core is as follows, where each R′ represents the divalent R′ group in Structure IA above; 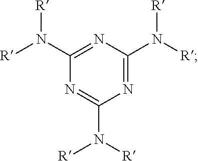
and
wherein each R group in Structure IA is independently selected from H, an unsubstituted hydrocarbyl, a substituted hydrocarbyl, an unsubstituted heterohydrocarbyl or a substituted heterohydrocarbyl;
Structure IB comprises sub-structure IB) as follows: 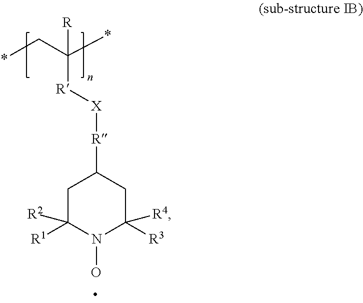
wherein n is an integer ≥1;
R1, R2, R3 and R4 are each independently selected from H or a C1-C18 alkyl;
X is selected from CH₂, ether (—O—), thioether (—Sₘ—, where m≥1), carbonyl (—C(O)—), ester (—O—C(O)— or —C(O)—O—), amine (—N(R)—), amide (—N(R)—C(O)— or —C(O)—N(R)—), urethane (—O—C(O)—NH— or —NH—C(O)—O—), carbamide (—NH—C(O)—NH—), or imide (—C(O)—N(R)—C(O)—);
R′ is selected from a C1-C30 alkylene;
R″ may or may not be present, and if present, R″ is selected from a C1-C30 alkylene;
each R group in sub-structure IB is independently selected from H, an unsubstituted hydrocarbyl, a substituted hydrocarbyl, an unsubstituted heterohydrocarbyl or a substituted heterohydrocarbyl;
each * (asterisk) in sub-structure IB represents the respective chemical end of Structure IB;
Structure IC comprises sub-structure IC) as follows: 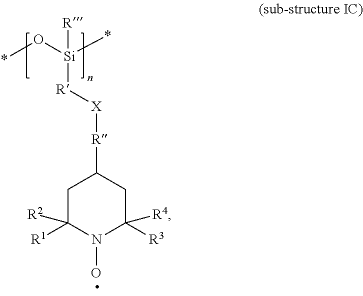
wherein n is an integer ≥1;
R1, R2, R3 and R4 are each independently selected from H or a C1-C18;
X is selected from CH₂, ether (—O—), thioether (—Sₘ—, where m≥1), carbonyl (—C(O)—), ester (—O—C(O)— or —C(O)—O—), amine (—N(R)—), amide (—N(R)—C(O)— or —C(O)—N(R)—), urethane (—O—C(O)—NH— or —NH—C(O)—O—), carbamide (—NH—C(O)—NH—), or imide (—C(O)—N(R)—C(O)—);
R′ is selected from a C1-C30 alkylene;
R″ may or may not be present, and if present, R″ is selected from a C1-C30 alkylene;
each R′″ group in sub-structure IC is independently selected from an unsubstituted hydrocarbyl, a substituted hydrocarbyl, an unsubstituted heterohydrocarbyl or a substituted heterohydrocarbyl;
each R group in sub-structure IC is independently selected from H, an unsubstituted hydrocarbyl, a substituted hydrocarbyl, an unsubstituted heterohydrocarbyl or a substituted heterohydrocarbyl;
each * (asterisk) in sub-structure IC represents the respective chemical end of Structure IC, and if n≥3, then each end may or may not form a cyclic structure with the other end.

2. The composition of claim 1, wherein the ethylene/alpha-olefin interpolymer is an unsaturated ethylene/alpha-olefin interpolymer of the formula A¹L¹.

3. The composition of claim 1, wherein the ethylene/alpha-olefin interpolymer is an ethylene/alpha-olefin copolymer.

4. The composition of claim 1, wherein component a further comprises a second ethylene/alpha-olefin interpolymer with a density from 0.855 to 0.900 g/cc, and a total unsaturation ≥0.20/1000 C, and this second interpolymer is different from the first ethylene/alpha-olefin interpolymer.

5. The composition of claim 4, wherein the second ethylene/alpha-olefin interpolymer is an unsaturated ethylene/alpha-olefin interpolymer of the formula A¹L¹.

6. The composition of claim 4, wherein the second ethylene/alpha-olefin interpolymer is an ethylene/alpha-olefin copolymer.

7. The composition of claim 4, wherein the ratio of the density of the ethylene/alpha-olefin to the density of the second ethylene/alpha-olefin is from 0.80 to 1.25.

8. The composition of claim 4, wherein the weight ratio of the ethylene/alpha-olefin to the second ethylene/alpha-olefin is from 0.50 to 20.

9. The composition of claim 1, wherein the composition comprises ≤10.0 wt % of a filler, based on the weight of the composition.

10. The composition of claim 1, wherein composition comprises from 90.0 wt % to 100.0 wt % of the sum of components a, b and c, based on the weight of the composition.

11. A crosslinked composition formed from the composition of claim 1.

12. An article comprising at least one component formed from the composition of claim 1.

13. A process to form a crosslinked composition, the process comprising thermally treating the composition of claim 1.

14. The process of claim 13, wherein the thermal treatment takes place in air.

15. The process of claim 13, wherein the thermal treatment takes place at a temperature ≥150° C.

16. A process to form a crosslinked composition, the process comprising at least the following steps A and B:
A) extruding a composition comprising the following components a) through c) to form a pre-crosslinked composition:
a) at least one ethylene/alpha-olefin interpolymer that comprises the following properties: i) a density 0.855 to 0.900 g/cc, and ii) a total unsaturation ≥0.20/1000 C,
b) at least one Tempo compound of Structure I, and wherein Structure I is selected from Structure IA, Structure IB or Structure IC, each as described herein; and
c) at least one peroxide;
B) thermally treating the pre-crosslinked composition in air, at a temperature ≥150° C., to form the crosslinked composition.

17. The process of claim 16, wherein, for step A, the composition is extruded at an average barrel temperature from 60° C. to 150° C.

18. The process of claim 16, wherein, for step B, the pre-crosslinked composition is thermally treated at a temperature from 150° C. to 240° C.

19. The process of claim 16, wherein the molar ratio of the NO· from component b to the peroxide (O—O) bonds from component c is from 0.30 to 0.90.

20. The process of claim 16, wherein, for the composition, component b is present in an amount from 0.20 to 0.90 phr, based on 100 parts of component a.
